(19) United States
(12) Patent Application Publication
(10) Pub. No.: US 2012/0067952 A1
(43) Pub. Date: Mar. 22, 2012

(54) Code Quality Evaluating Apparatus

(75) Inventor: Hajime Matsuda, Osaka (JP)

(73) Assignee: KEYENCE CORPORATION, Osaka (JP)

(21) Appl. No.: 13/205,927

(22) Filed: Aug. 9, 2011

(30) Foreign Application Priority Data
Sep. 17, 2010 (JP) 2010-210245

(51) Int. Cl. G06K 5/00

(52) U.S. Cl. 235/437

(57) ABSTRACT

Quality of a code provided in a test piece of a work is evaluated, using a sample processing function of a marker that gives the code to the work to present suggestion for setting of a processing condition to a user. Images picked up by a bar code reader are taken in to create a list of readable codes from these picked-up images, and images of these readable codes are displayed in a list. Tuning processing is performed to all the listed-up codes. In this tuning processing, the reading is tried while changing brightness, and a barometer of readability (easiness of decoding) in each of the reading trials is found to calculate a score indicating a level of reading stability based on a value of integral of this barometer, and this score is displayed as a numeric value and in a graph.

### CROSS-REFERENCE TO RELATED APPLICATIONS

The present application claims foreign priority based on Japanese Patent Application No. 2010-210245, filed Sep. 17, 2010, the contents of which is incorporated herein by reference.

### BACKGROUND OF THE INVENTION

1. Field of the Invention

The present invention relates to a code quality evaluating apparatus that evaluates quality of a code such as a bar code, a QR code, or the like.

2. Description of the Related Art

Now that traceability is widespread, many industries have employed a system in which an optical information reading apparatus called a bar code reader or a code reader is installed in a factory, a physical distribution complex and the like. A code such as a bar code is processed or inscribed to a product or a commodity, and information of the code is read by the optical information reading apparatus.

Japanese Unexamined Patent Publication No. H11-28586 discloses a laser marker that inscribes a code to a work using laser light. Japanese Unexamined Patent Publication No. 2008-33465 discloses a bar code reader that irradiates optical information with laser light, visible light or infrared light, and takes in reflected light in an optical reading element (an imaging element) to read the code, that is, the optical information. There has been known a bar code reader that has illumination LEDs incorporated therein in order to execute imaging of the optical information while irradiating the optical information with the light of the illumination LEDs (Japanese Unexamined Patent Publication No. 2008-33465). However, in case of a shortage in an amount of light of these internal illumination LEDs, an external illumination unit separate from the bar code reader has been marketed (Japanese Unexamined Patent Publication No. H04-241476).

For the laser marker, a processing condition is set by a user in advance, and in accordance with the setting values, processing is executed by the laser marker. Although it is not specific to the laser marker, a conventional method relating to the setting of the processing condition will be described taking the laser marker as one example. A code processing is actually inscribed on a test piece of a work, using the laser marker, and a user determines good or poor by viewing this inscribed code. The processing test using the test piece is conducted using a sample processing function of the laser marker. The sample function is a function of executing the processing by changing parameters such as a laser output and a scanning speed, that is, by changing the processing condition. By viewing many codes, the user decides, as the setting values of the laser marker, the processing condition of the code under which he or she determines that processing quality thereof enables the reading by the bar code reader without any problem.

However, it is not easy to determine whether the code provided in the sample piece of the work is good or poor, using the sample processing function. Particularly, it is known that in a code directly inscribed to a work, which is called direct part marking, and in a code given to a work with a fine grinding trace on a surface, which is called hairline work, a way to throw the light is a factor that affects the reading of the bar code reader.

Accordingly, in some cases, even the code that the user determines that there is no problem by viewing may be difficult for the bar code reader to read. When there are a plurality of codes, which are similar enough when viewed by the user that there is no problem even if any one is selected, one of the codes may be read more stably in view of determination on the bar code reader side.

Since it is not a person but the bar code reader that reads the code, it gives the user benefits to suggest an optimal code from a number of codes of the sample pieces under an illumination condition and a reading condition of the bar code reader, and it is also rational.

### SUMMARY OF THE INVENTION

An object of the present invention is to provide a code quality evaluating apparatus capable of evaluating quality of a code from an optical information reading apparatus side, and presenting suggestion of setting of a processing condition to a user.

Another object of the present invention is to provide a code quality evaluating apparatus capable of evaluating quality of a code provided on a test piece of a work, using a sample processing function included in a marker that gives the code to the work, and presenting suggestion of setting of a processing condition to a user.

According to the present invention, the above-described technical objects are achieved by providing a code quality evaluating apparatus that is connected to an optical information reading apparatus, and acquires images picked up by the optical information reading apparatus to evaluate quality of codes included in the picked-up images, the code quality evaluating apparatus including:

an image taking-in device that takes in the picked-up images obtained by the optical information reading apparatus imaging the codes given to a work;

a code extracting device that extracts the readable codes from the picked-up images;

a score calculating device that performs reading trial to the codes extracted by the code extracting device while changing an imaging parameter, and calculates scores of reading stability of the extracted codes with respect to the change of the imaging parameter, based on results of the reading trial; and

a display device that displays the images of the codes together with the scores calculated by the score calculating device.

That is, according to the present invention, the code is imaged by the optical information reading apparatus, and the scores of the reading stability of the codes in the picked-up images are displayed, the scores being obtained by the results from the reading trial to the codes while changing the imaging parameter with respect to the codes in the picked-up images, by which suggestion of the processing condition setting can be presented to the user. The imaging parameter may include the brightness, filtering, a lighting pattern, and the like, and a barometer of the readability may be found by changing only one of the parameters or by changing the plurality of parameters.

According to a preferred embodiment of the present invention, the code extracting device extracts the readable codes by performing the reading trial while changing brightness for the codes. In this manner, in this process of extracting the codes, the reading trial is performed by changing the brightness for the codes, which enables the readable codes to be widely extracted.

According to a preferred embodiment of the present invention, the score calculating device performs the reading trial while narrowing down a reading region to each of the codes extracted by the code extracting device and changing the brightness. By limiting a size of the reading region to the code, the reading trial that is less affected by the way to throw light can be executed.

Moreover, according to a preferred embodiment of the present invention, the score is calculated based on a barometer of readability by the reading trial. Not a peak of the readability (easiness of decoding) but a value of integral of each of the barometers in the reading trial is employed to calculate the score, by which a rough indication of a level of the reading stability of the code can be presented to the user, using the level of the score.

Other objects, and operation and effects of the present invention will be clear from the detailed description of the preferred embodiments of the present invention given below.

### BRIEF DESCRIPTION OF THE DRAWINGS

FIG. 1 is an overall configuration diagram of a bar code reader system;

FIG. 2 is a perspective view of a bar code reader, which is an optical information reading apparatus;

FIG. 3 is a view when arrangement of various types of substrates arranged inside the bar code reader is seen from an obliquely front side;

FIG. 4 is a view related to FIG. 3, wherein the arrangement of the various types of substrates arranged inside the bar code reader is seen from an obliquely rear side;

FIG. 5 is a view for describing connection wiring relationships of the various types of substrates incorporated in the bar code reader;

FIG. 6 is a view for describing arrangement of a chassis incorporated in the bar code reader, and a main substrate, a power supply substrate, and a sub substrate assembled to the chassis;

FIG. 7 is a view for describing various elements assembled to the chassis;

FIG. 8 is a view when a camera module is seen from an obliquely rear side;

FIG. 9 is a view when the camera module is seen from an obliquely front side;

FIG. 10 is a conceptual view for describing an internal structure of the camera module;

FIG. 11 is a view showing relationships between the camera module and the various types of substrates, wherein the bar code reader is contained in a main case of the bar code reader in this state;

FIG. 12 is a view showing the relationships between the camera module and the various types of substrates as in FIG. 11, wherein as a preferable example, thermally conductive rubbers as heat releasing members are placed on the power supply substrate and the main substrate;

FIG. 13 is a view for describing a state where the thermally conductive rubbers abut on the power supply substrate, the main substrate, and the main case in connection with FIG. 12;

FIG. 14 is a view for describing that an LED substrate (internal illumination substrate) is attached to front end surfaces of a pair of rod-like extended portions extending forward from the main case, and front ends of the power supply substrate and the main substrate are fixed to the extended portions;

FIG. 15 is an exploded perspective view for describing the main case of the bar code reader, and how an open rear end of the main case is closed by a rear case, wherein a connector substrate is fixed to the rear case;

FIG. 16 is a front view of the main case containing incorporated members illustrated in FIG. 15;

FIG. 17 is a front view of the main case in a state where the camera module is removed from FIG. 16;

FIG. 18 is a functional configuration diagram of the bar code reader;

FIG. 19 is a diagram for describing a relationship between an image buffer and a shared memory of the bar code reader;

FIG. 20 is a diagram for describing that a plurality of setting banks are stored in the shared memory;

FIG. 21 is a view showing a state where an external illumination unit is attached to the bar code reader;

FIG. 22 is an exploded perspective view of the external illumination unit;

FIG. 23 is a perspective view of the LED substrate with LEDs to be incorporated in the external illumination unit;

FIG. 24 is a diagram for describing attachment relationships of two substrates assembled to the external illumination unit;

FIG. 25 is a front view of an internal illumination unit, which is incorporated in the bar code reader, and is a surface light source with the plurality of LEDs arrayed two-dimensionally, and a view for describing that LEDs included in the internal illumination unit are divided into a plurality of areas, and the lighting control is enabled on the area basis;

FIG. 26 is a front view of the dedicated external illumination unit having the large diameter, and is a view for describing that LEDs included in this external illumination unit are divided into a plurality of areas to control lighting on the area basis;

FIG. 27 is a front view of the dedicated external illumination unit having the small diameter, and is a view for describing that LEDs included in this external illumination unit are divided into a plurality of areas to control lighting on the area basis;

FIG. 28 is a diagram showing one example of an LED drive circuit each incorporated in the internal illumination unit and the external illumination unit

FIG. 29 is a system diagram for controlling partial illumination of the internal illumination unit and the external illumination unit;

FIG. 30 is a view showing a user interface screen displayed when a work is positioned with respect to the bar code reader;

FIG. 31 is a view showing the user interface screen displayed when an optical information reading region is set and brightness of the region is adjusted;

FIG. 32 is a view showing a lighting pattern setting screen and a display aspect when the external illumination unit is connected to the bar code reader;

FIG. 33 is a view showing a lighting pattern setting screen as in FIG. 32, and showing that a schematic diagram of partial illumination areas of the internal illumination unit is displayed when the external illumination unit is unconnected;

FIG. 34 is a view showing a setting screen in tuning;

FIG. 35 is a view showing a user interface screen during execution of tuning processing;

FIG. 36 is a view showing the user interface screen during execution of the reading trial in the tuning;

FIG. 37 is a view showing the user interface screen during a bank addition processing;

FIG. 38 is a view showing the user interface screen during analysis processing of an NG image;

FIG. 39 is a flowchart for describing a specific example of the tuning processing;

FIG. 40 is a view showing a user interface screen displayed by activation of a code quality evaluating program;

FIG. 41 is a flowchart for describing processing of the code quality evaluating program;

FIG. 42 is a view showing the user interface screen displayed during the tuning processing of the code quality evaluating program, and an example in which an integral value (score) of the barometer of the readability (easiness of the decoding) is relatively large; and

FIG. 43 is a view showing the user interface screen displayed during the tuning processing of the code quality evaluating program as in FIG. 42, and an example in which the integral value (score) of the barometer of the readability (easiness of the decoding) is relatively small.

### DETAILED DESCRIPTION OF THE PREFERRED EMBODIMENTS

### Embodiment

Hereinafter, a preferred embodiment of the present invention will be described based on the accompanying drawings.

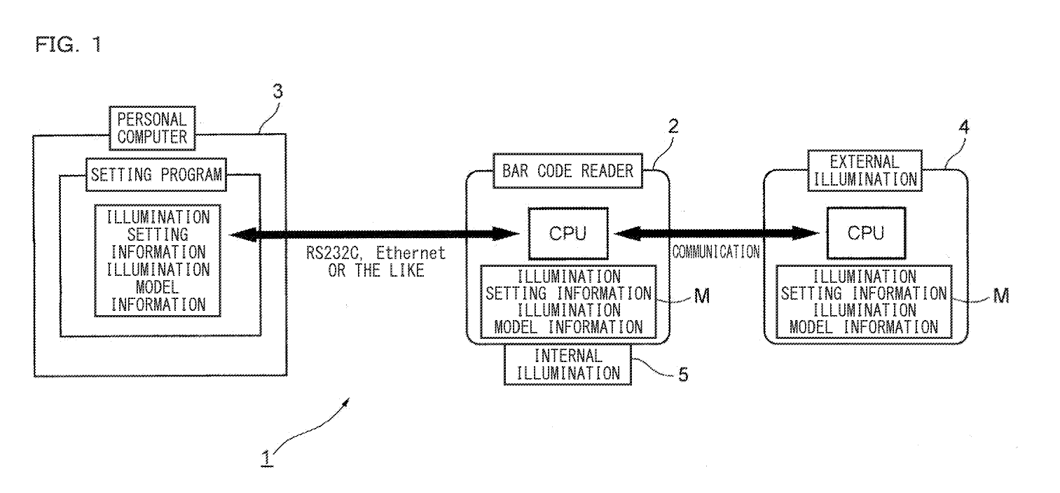

### Bar Code Reader System (FIG. 1):

FIG. 1 is a diagram for describing an outline of a bar code reader system. Referring to FIG. 1, a bar code reader system 1 has a bar code reader 2, which is a two-dimensional information reading apparatus, and a personal computer 3 connected to the bar code reader 2 as needed, and makes various settings using the personal computer 3 while checking, on the personal computer 3, an image picked up by the bar code reader 2. In the bar code reader system 1, a ring-type external illumination unit 4 is further connected to the bar code reader 2 as needed to illuminate a work together with an internal illumination unit 5 of the bar code reader 2, or only by the external illumination unit 4 with operation of the internal illumination unit 5 stopped.

The ring-type external illumination unit 4 is a dedicated member for the bar code reader system 1. It is preferable to prepare a plurality of different types of external illumination units 4. Obviously, an illumination unit other than the dedicated member can be incorporated as the external illumination unit 4. The “optical information reading apparatus” is generally called a “bar code reader” or a “code reader”, and herein, an industry term, the “bar code reader” is used.

The bar code reader system 1 is installed in a conveyance path of products or goods in a factory where the products or goods on which optical information or an optical code such as barcode or QR code is processed are manufactured, so that information recorded in the optical information processed or inscribed on the products or goods is read by the bar code reader 2, and this information is transferred to the personal computer 3 to analyze the information. An “optical information reading apparatus” is generally called a “bar code reader” or a “code reader”, and herein, an industry term, “bar code reader” is used.

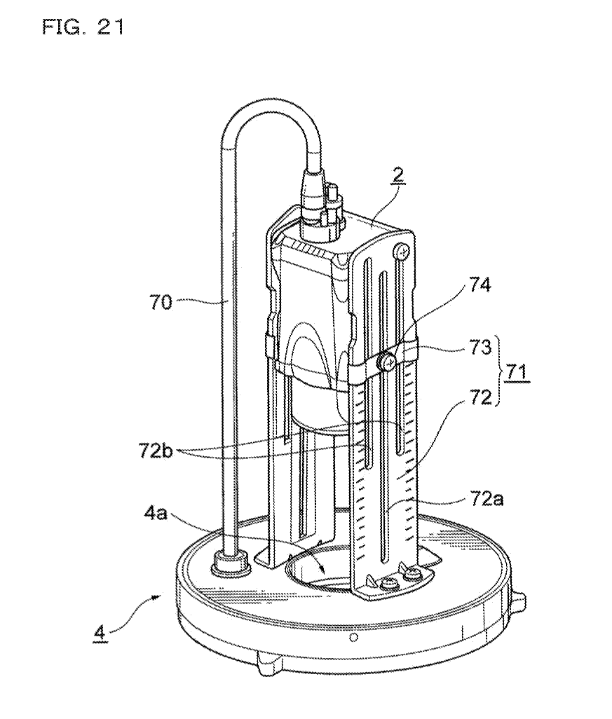

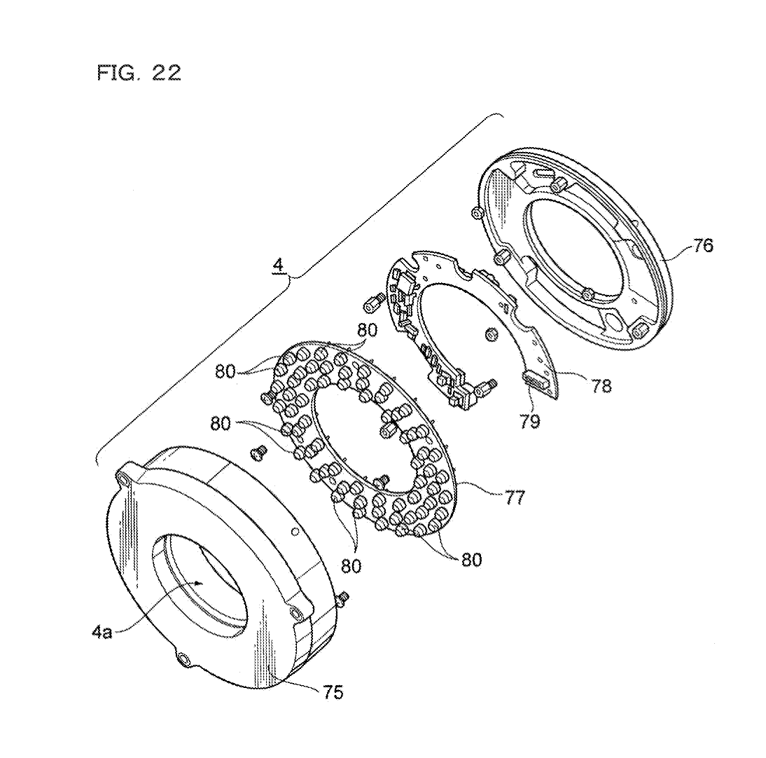

In an example shown in the figure, as disclosed in FIG. 1, a setting program is installed on the personal computer 3, by which using the personal computer 3, various settings of the bar code reader system 1 are made. Obviously, the bar code reader 2 may be provided, for example, with a display device with a touch panel to enable setting work of the bar code reader 2, the internal illumination unit 5 (FIG. 3), and/or the external illumination unit 4 (FIGS. 21 and 22), using this display device.

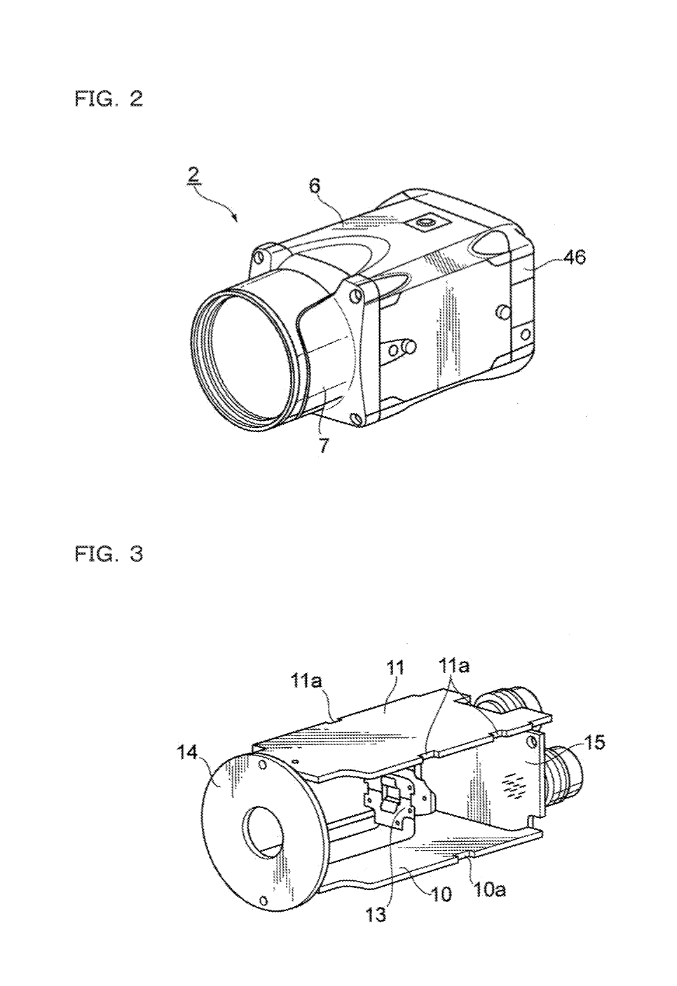

### Bar Code Reader 2 (FIGS. 2 to 17):

FIG. 2 is a perspective view showing an appearance of the bar code reader 2. The bar code reader 2 has a main case 6 having a polygonal cross-sectional shape, and a cylindrical front case 7 fixed to a front end of the main case 6, and the foregoing internal illumination unit 5 is incorporated in the cylindrical front case 7. The main case 6 preferably has a substantially square cross-sectional shape, as seen from FIG. 2 and the like.

A plurality of substrates independent from one another are incorporated in the bar code reader 2. Referring to FIGS. 3 to 5, the plurality of substrates included in the bar code reader 2 are as follows.

### (1) Main Substrate 10:

In a main substrate 10, a CPU and a memory M are mounted to transfer an image to the memory M and process the image in a DSP (Digital Signal Processor). The bar code reader 2 including the internal illumination unit 5 is controlled by the CPU of the main substrate 10, and communication with the external illumination unit 4 is executed.

### (2) Power Supply Substrate 11:

A power supply of the bar code reader 2 is generated. An insulated input and output circuit is installed.

### (3) Sub Substrate 12:

A large-capacity memory is mounted and an acquired image and various settings are stored in this large-capacity memory. On this substrate, elements that cannot be mounted on the main substrate 10 with a limited size and shape are mounted.

### (4) CMOS Substrate 13 (Light-receiving Substrate):

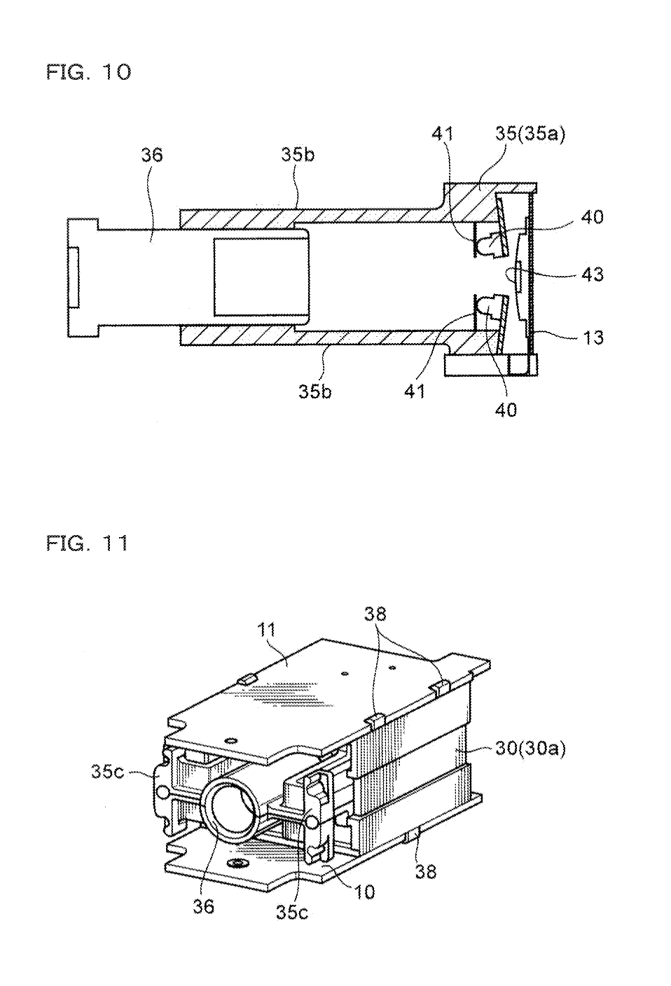

A CMOS image sensor (optical reading element) is installed, so that the image is acquired and transferred to the main substrate 10. LEDs 40 for pointer (FIG. 10) are mounted.

### (5) LED Substrate 14:

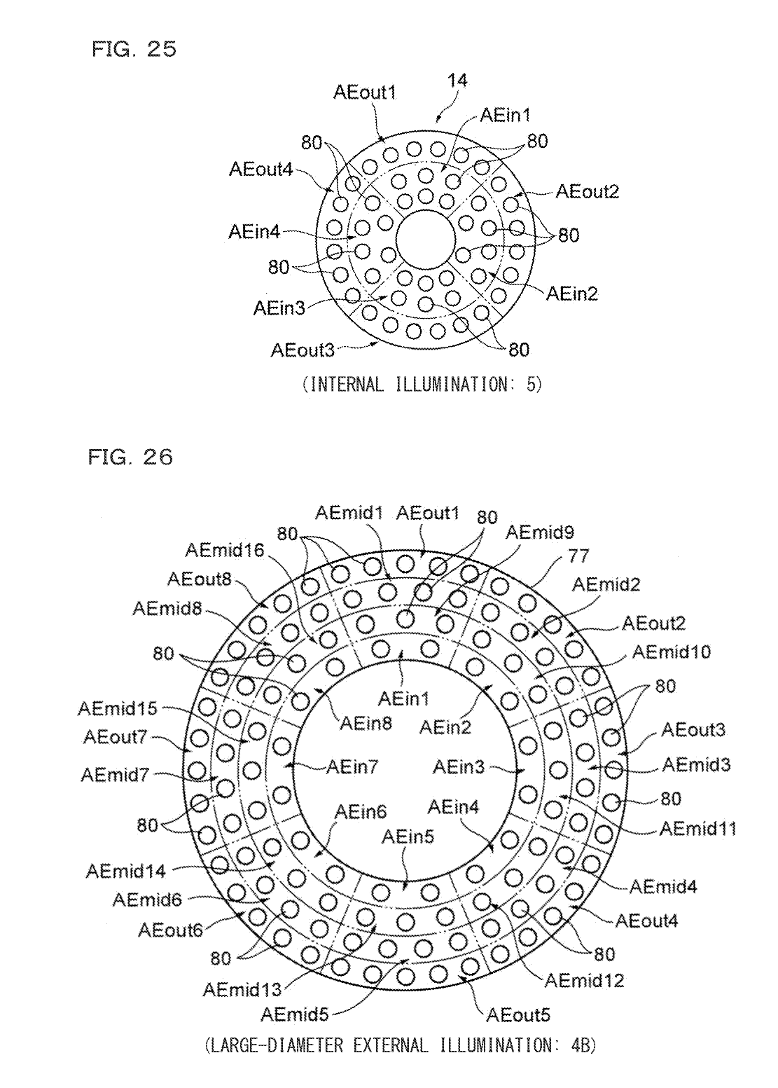

An LED substrate 14 is a disc-like substrate with a circular opening 14a making up the internal illumination unit 5. A plurality of illumination LEDs 80 are installed on the LED substrate 14 (FIG. 25 described later), so that lighting control of the illumination LEDs 80 is executed. The plurality of illumination LEDs 80 are arrayed on a plurality of concentric circles with different diameters centering on an optical axis of a later-described lens assembly 36 of the bar code reader 2. The plurality of illumination LEDs 80 installed in the internal illumination unit 5 (in the LED substrate 14) are subjected to the light control by being divided into areas as will be described later. In the LED substrate 14, constant current circuits that supply a constant current to the plurality of illumination LEDs belonging to the respective areas are provided.

### (6) Connector Substrate 15:

A connector substrate 15 is a substrate making up an interface of input and output with respect to an external power supply, an IO, an RS232C, Ethernet (registered trademark), and the external illumination unit 4. Power is supplied to the external illumination unit 4 from the power supply substrate 11.

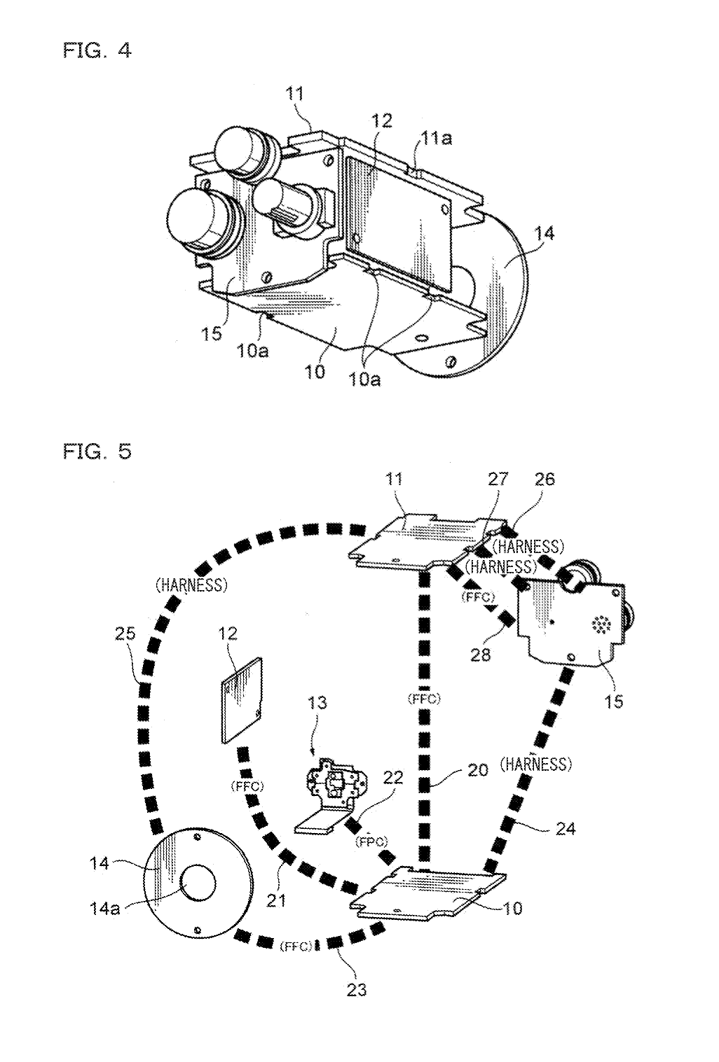

Referring to FIGS. 3 and 4, the main substrate 10 and the power supply substrate 11 are arranged in opposition to each other, and in a region sandwiched by respective side edges of the main substrate 10 and the power supply substrate 11, the sub substrate 12 is provided orthogonally to the main substrate 10 and the power supply substrate 11. An arrangement position of the sub substrate 12 and the main substrate 10 may be exchanged. The main substrate 10, the power supply substrate 11, and the sub substrate 12 are disposed adjacent to three side surfaces of four side surfaces of the main case 6 having a rectangular cross section in the bar code reader 2, and along the respective three side surfaces. The CMOS substrate 13 is located in a space surrounded by the main substrate 10, the power supply substrate 11 and the sub substrate 12, and the CMOS substrate 13 is disposed on one vertical surface orthogonal to the respective substrates 10 to 12. The LED substrate 14 and the connector substrate 15 are positioned parallel to the CMOS substrate 13 so as to be opposed to each other with the CMOS substrate 13 interposed therebetween.

FIG. 5 is a view for describing connection relationships of the substrates 10 to 15. The main substrate 10 is connected to the power supply substrate 11 through a first FFC 20 (Flexible Flat Cable) and to the sub substrate 12 through a second FFC 21, to the CMOS substrate 13 through an FPC (Flexible Printed Circuit) 22, to the LED substrate 14 of the internal illumination unit 5 through a third FFC 23, and to the connector substrate 15 through a first harness 24. The power supply substrate 11 is also connected to the LED substrate 14 of the internal illumination unit 5 through a second harness 25, so that the power supply to cause the illumination LEDs installed in the LED substrate 14 to emit light is supplied from the power supply substrate 11 to the LED substrate 14. The power supply substrate 11 and the connector substrate 15 are connected through two harnesses 26, 27 and an FFC 28.

Referring again to FIG. 5, it should be noted that the main substrate 10 and the power supply substrate 11 have substantially the same size and shape. In other words, the main substrate 10 is designed to have substantially the same size and shape as the power supply substrate 11, and electronic components that cannot be mounted on the main substrate 10 because of these limitations are mounted on the sub substrate 12.

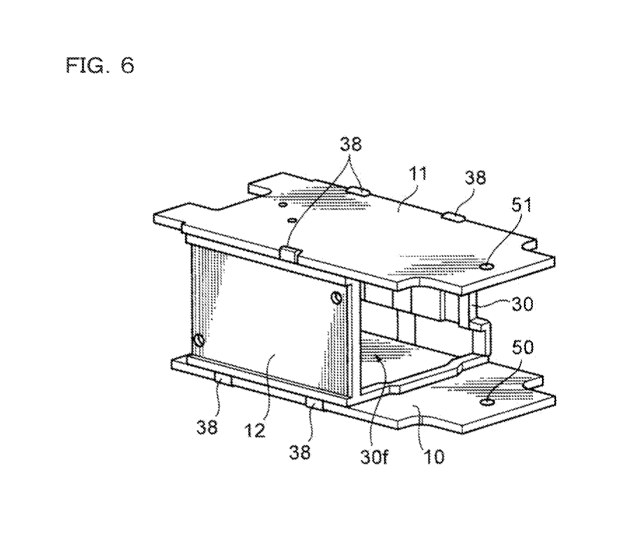

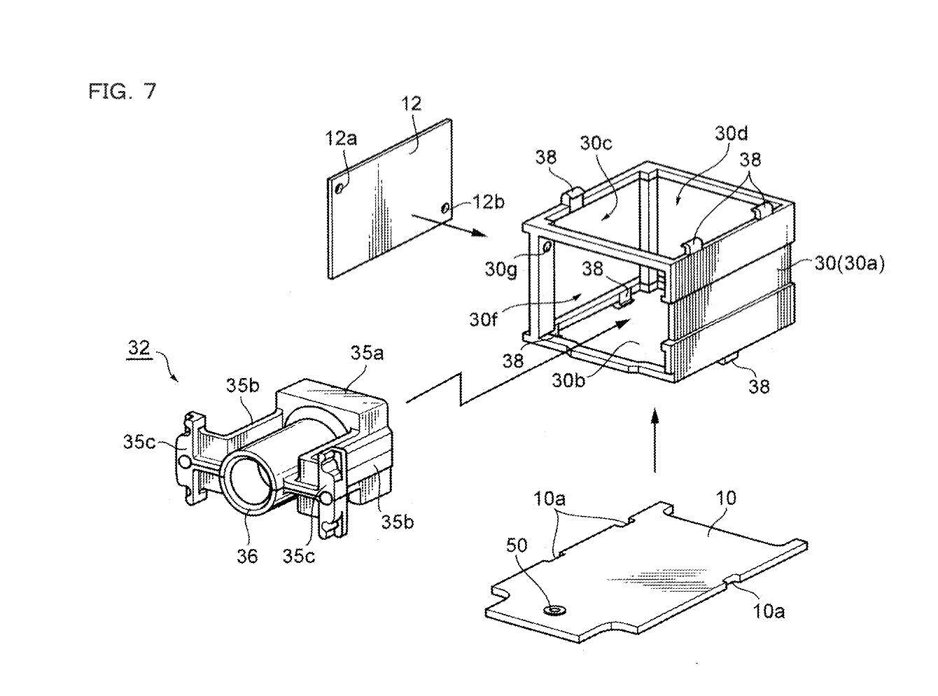

Referring to FIGS. 6 and 7, the main substrate 10, the power supply substrate 11, the sub substrate 12, and the CMOS substrate 13 are assembled to a chassis 30, which is a resin molded article. As best seen in FIG. 7, the chassis 30 has a box shape having a substantially square cross-sectional shape, which is an almost similar shape to the cross-sectional shape of the main case 6, and has a form in which one side surface 30a of this box shape is closed and the other five surfaces are open. The main substrate 10, the power supply substrate 11, and the sub substrate 12 are disposed on three open side surfaces 10b to 10d, respectively. The chassis 30 of the resin molded article is open at the front and rear thereof, and a camera module 32 is inserted from a one-end opening 30f (FIG. 7). The main substrate 10, the power supply substrate 11, and the sub substrate 12 are located around the camera module 32 inserted into the chassis 30, which brings a state where the camera module 32 is encompassed by the main substrate 10, the power supply substrate 11, and the sub substrate 12.

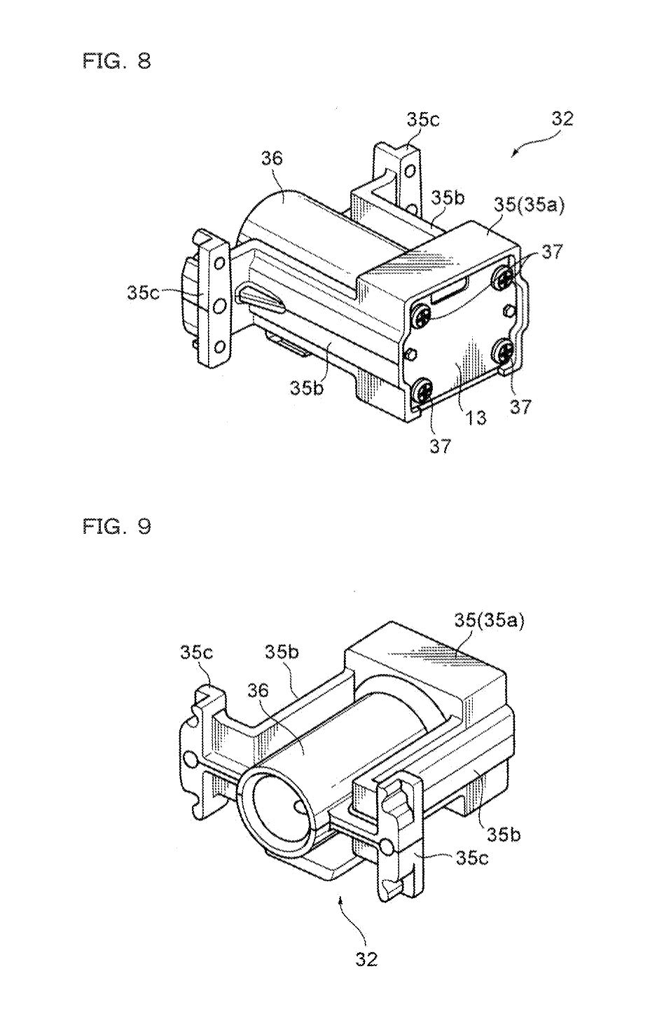

Referring to FIGS. 8 and 9, the camera module 32 has a camera holder 35 made of a die casting material such as aluminum, and the camera holder 35 has a holder body 35a having a rectangular cross section, a pair of arms 35b extending forward and parallel to each other from side surfaces of the holder body 35a opposed to each other, and a pair of attachment portions 35c extending from front ends of the pair of arms 35b in directions away from each other. The CMOS substrate 13 is fixed to a rear end surface opening rearward of the holder body 35a by a plurality of screws 37 (FIG. 8).

For positioning of the main substrate 10 and the power supply substrate 11, six claws 38 are integrally formed in the chassis 30 (FIG. 7), and using these six claws 38, the main substrate 10 and the power supply substrate 11 opposed to the same are positioned on two open side surfaces 30b, 30d of the chassis 30 opposed to each other, respectively. Cut-outs 10a to receive the claws 38 are formed in the main substrate 10 (FIG. 7). Cut-outs 11a are similarly formed in the power supply substrate 11 (FIG. 3). Referring to FIG. 7, the rectangular sub substrate 12 has a pair of through-holes 12a, 12b at diagonally opposite corner portions, and a pair of through-holes 30g (one of the through-hole does not appear in the drawing for a drawing reason) is formed in the chassis 30 corresponding to the pair of through-holes 12a, 12b. These through-holes 12a, 12b, and 30g are matched, which allows the sub substrate 12 to be mounted on the chassis 30 by the screws.

### Arrangement of LEDs for Pointer (FIG. 10):

The camera module 32 has the cylindrical lens assembly 36, and the lens assembly 36 is disposed between the pair of arms 35b, 35b of the camera holder 35. Referring to FIG. 10, the CMOS substrate 13 is fixed to a rear-end opening of the holder body 35a, using the screws 37 (FIG. 8). A pair of LEDs 40, 40 for pointer is mounted on the CMOS substrate 13. In connection with the LEDs 40 for pointer, diffusion sheets 41 are disposed immediately in front of the respective LEDs 40 for pointer in the holder body 35a. Light of the two LEDs 40 for pointer is radiated forward through the diffusion sheets 41 and the lens assembly 36, and points to two points at a distance from each other within a visual field range of the bar code reader 2. Reference numeral 43 in FIG. 10 denotes a CMOS image sensor which is an optical reading element, and the optical reading element 43 is installed in the CMOS substrate 13.

The LEDs 40 for pointer are incorporated in the camera module 32, which makes it easy to keep a relational position between the optical reading element 43 and the LEDs 40 for pointer constant, and to downsize the bar code reader 2. Particularly, the LEDs 40 for pointer share the lens assembly body 36 of the bar code reader 2 with the optical reading element 43, which makes it easy to downsize the bar code reader 2 because dedicated lenses for the LEDs 40 for pointer become unnecessary.

The camera module 32 is characterized in that a distance between the optical reading element (image pickup element) 43 and the lens assembly 36 is very large as compared with a case in the related art, and that in the optical information such as the bar code and the QR code, even an ultramicro region thereof can be read with a high resolution. When the camera module 32 larger in length dimension as compared with the related art is contained in the bar code reader 2, the above-described substrate arrangement should be noted. That is, introducing the technical idea of surrounding the camera module 32 by the main substrate 10, the power supply substrate 11 and the sub substrate 12 enables the long camera module 32 to be contained in the outer case while downsizing the bar code reader 2.

Specifications of the camera module 32 are as follows.
(1) Optical magnification: 0.6 to 1.0 fold (in the embodiment, 0.823 fold)
(2) Visual field range: 7.5 mm×4.8 mm to 4.5 mm×2.9 mm (in the embodiment, 5.5 mm×3.5 mm)
(3) Distance from the optical reading element to the lens at a fore-end: 35 mm or more (in the embodiment, 40 mm)

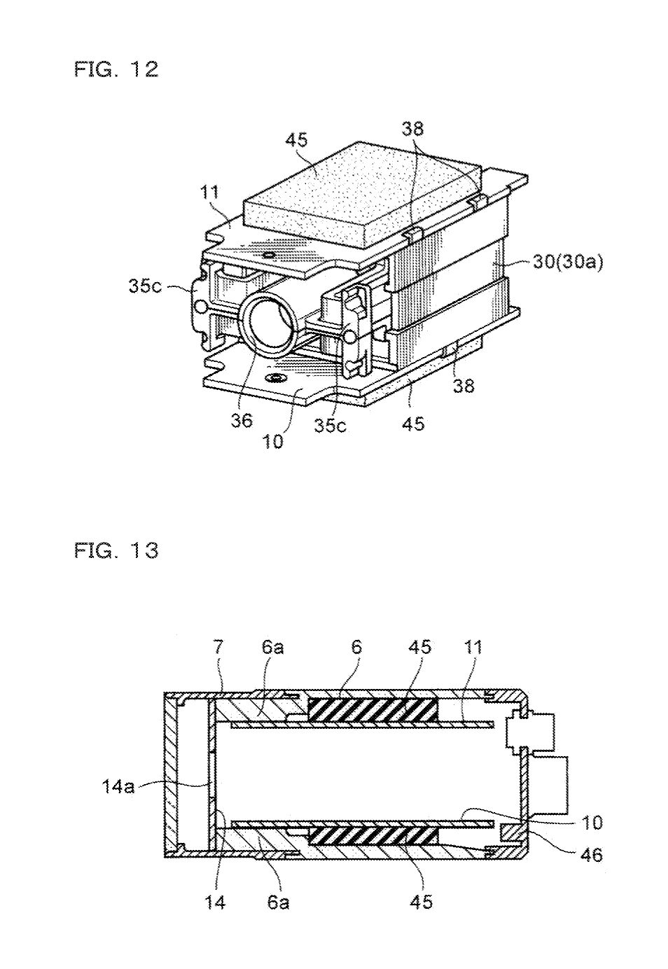

FIG. 11 is a perspective view of an assembly in which the substrates 10, 11, 12 and the camera module 32 are assembled to the chassis 30. FIG. 12 shows a state where thermally conductive rubbers 45 are respectively placed on the main substrate 10 and the power supply substrate 11 as heat releasing members having cushion properties and excellent thermal conductivity. If the heat release properties of the bar code reader 2 are required, the assembly is contained in the main case 6 (FIG. 2) having the rectangular cross section with the thermally conductive rubbers 45 attached in the aspect illustrated in FIG. 12 (FIG. 13).

The main substrate 10 and the power supply substrate 11 are arranged adjacent to, and along the different side surfaces of the main case 6 having the polygonal cross section and made of a metal material excellent in thermal conductivity, which makes it easy to release heat of the main substrate 10 and the power supply substrate 11 outside, and enables the camera modules 32 to be contained in the space surrounded by the main substrate 10 and the power source substrate 11, thereby enabling the further downsizing of the bar code reader 2. Particularly, interposing the heat releasing members such as the thermally conductive rubbers 45 between the main substrate 10 and the main case 6, and between the power substrate 11 and the main case 6, can increase heat release efficiency, and can further downsize the bar code reader 2 from this view point.

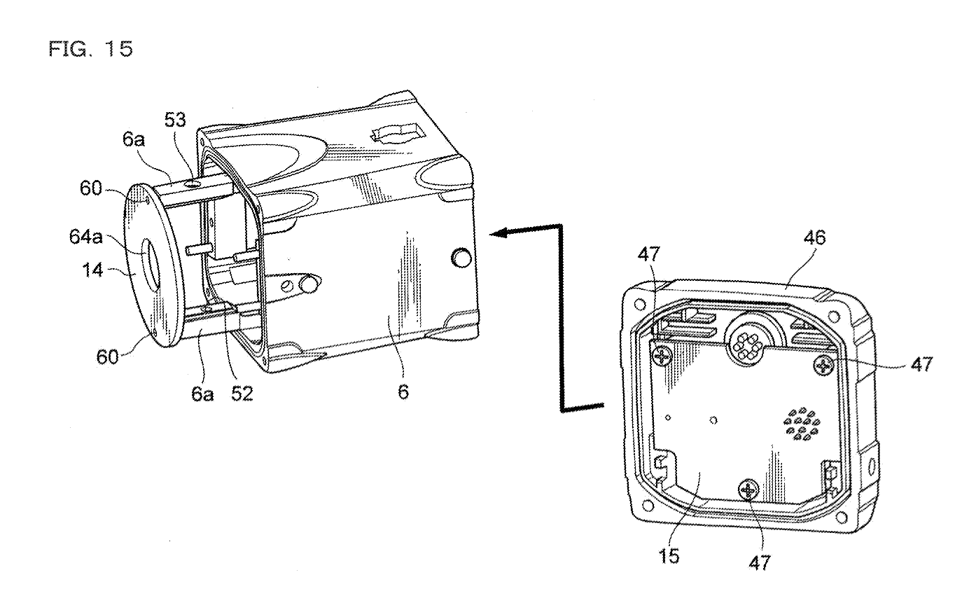

Reference numeral 46 in FIGS. 13 and 15 denotes a rear case, which is detachably attached to a rear-end opening of the main case 6 to close the main case 6. The connector substrate 15 is attached to the rear case 46 and the connector substrate 15 is fixed to the rear case 46 using screws 47 (FIG. 15). For example, the main case 6, the front case 7, and the rear case 46 making up the outer case of the bar code reader 2 is preferably made of a metal material excellent in thermal conductivity, for example, a thermally conductive material such as aluminum.

Referring to FIG. 6, the main substrate 10 and the power source substrate 11 have through-holes 50, 51 in front-end narrow-width portions, respectively. The main case 6 of the bar code reader 2 has a pair of rod-like extended portions 6a, which extend parallel to each other and forward to an inside of the cylindrical front case 7 (FIG. 15).

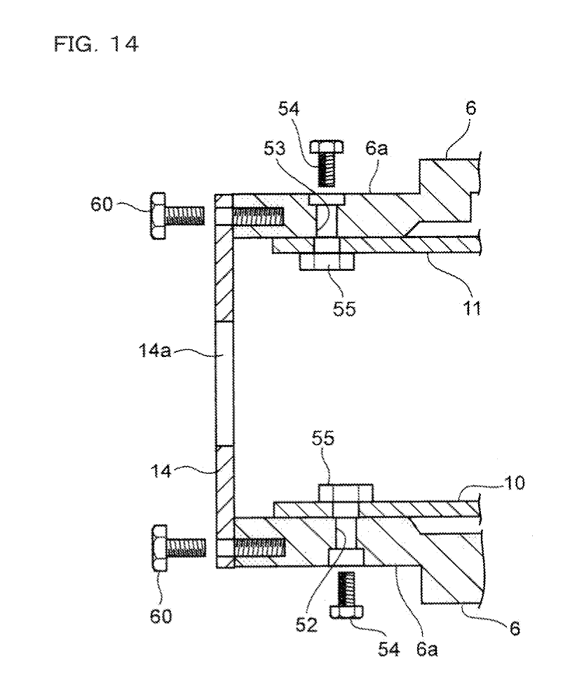

Referring to FIG. 14 in which a front end portion of the main case 6 is extracted, through-holes 52, 53 related to the through-holes 50, 51 of the front-end narrow-width portions of the main substrate 10 and the power supply substrate 11 are formed in the pair of extended portions 6a of the main case 6, and using screws 54 inserted into these through-holes 52, 53, the main substrate 10 and the power supply substrate 11 are fixed to the main case 6 (the extended portions 6a). This allows each of the main substrate 10 and the power supply substrate 11 positioned by the three claws 38 of the chassis 30 to be fixed to each of the extended portions 6a extending forward of the main case 6 by one of the screws 54. In other words, the chassis 30 is fixed to the main case 6 by the total of two screws 54. In order to facilitate work of tightening the screws 54 and work of removing the screws 54, nuts 55 into which the screws 54 are screwed are preferably installed at the through-hole 50 of the main substrate 10 and the through-hole 51 of the power supply substrate 11. To the pair of rod-like extended portions 6a of the main case 6 is fixed the ring-shaped LED substrate 14 at a front-end surface thereof by screws 60. The ring-shaped LED substrate 14 is arranged around the lens assembly 36, and the plurality of illumination LEDs 80 mounted on the LED substrate 14 form a ring-shaped surface light source located on the outer circumferential side of the lens assembly 36.

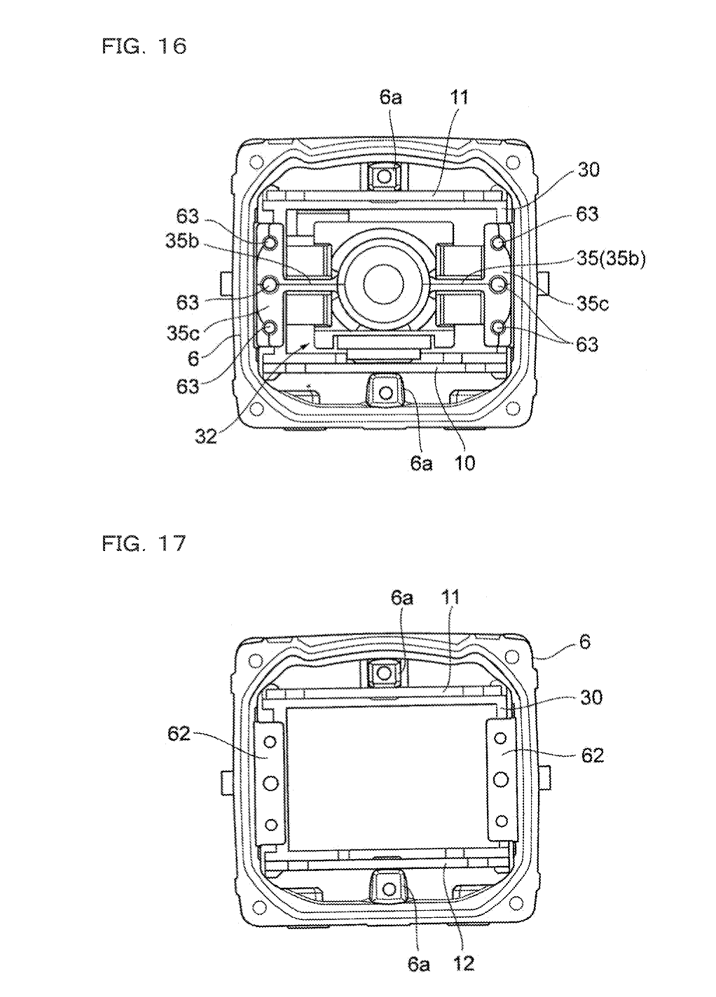

FIG. 17 is a view when the main case 6 is seen from the front side. The main case 6 has a pair of right and left attachment seats 62 in the front-end surface thereof, and the camera module 32 is fixed to the main case 6, using this pair of attachment seats 62. FIG. 16 is a front view of the main case 6 with the camera module 32 incorporated therein. FIG. 17 is a front view of the main case 6 illustrated in a state where the camera module 32 is removed.

Fixing the camera module 32 to the main case 6, which is a metal molded article, can increase positioning accuracy of the camera module 32, thereby increasing positioning accuracy of the visual field range, as compared with a case where the camera module 32 is fixed to the chassis 30.

Since there is employed a configuration in which the assembly in which the major substrates incorporated in the bar code reader 2, that is, the power supply substrate 11, the main substrate 10, and the like, and the camera module 32 including the lens assembly 36 are assembled to the chassis is incorporated in the outer case (main case 6), preparing a plurality of types of camera modules 32 enables a plurality of types of bar code readers 2 to be provided to a user, using the same outer case. For the different types of camera modules 32, the same power supply substrate 11, the main substrate 10, and the like are employed, and the same outer case is used to manufacture the bar code reader 2.

The pair of right and left attachment portions 35c of the camera module 32 are seated on the pair of right and left attachment seats 62 of the main case 6, and the respective attachment portions 35c are fixed to the corresponding attachment seats 62, using four screws 63 (FIG. 16).

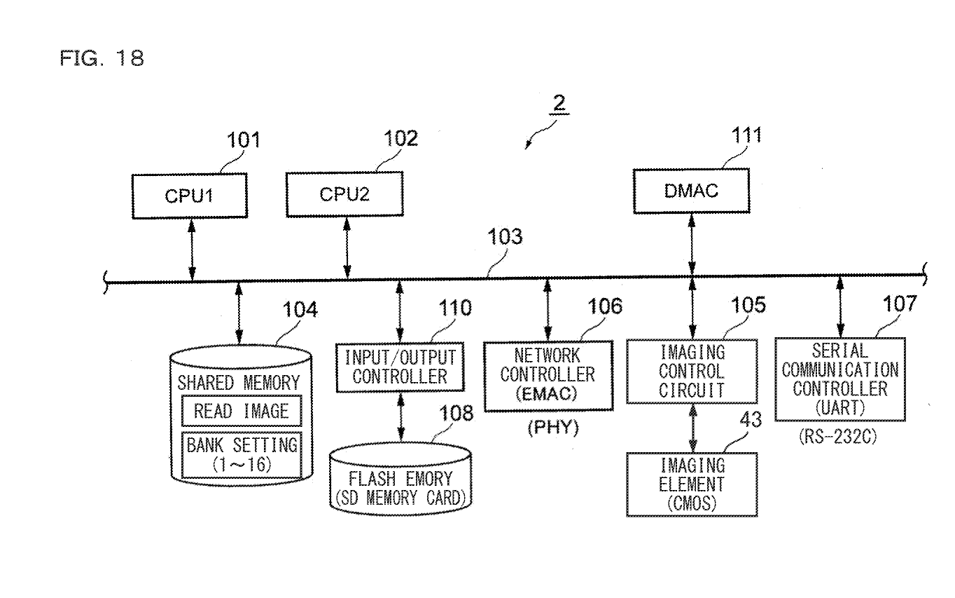

### Functional Configuration of Bar Code Reader 2 (FIG. 18):

Referring to FIG. 18, a functional configuration of the bar code reader 2 will be described. The bar code reader 2 has first and second CPUs 101, 102, a shared bus 103, a shared memory 104, the foregoing optical reading element (CMOS) 43, and an imaging control circuit 105. Moreover, the bar code reader 2 has a network controller 106, a serial communication controller 107, a flash memory 108, an input/output controller 110, and a DMAC 111.

First and second CPUs 101, 102 are processors that access the shared memory 104 through the shared bus 103, and are each made of a predetermined arithmetic operation circuit. The shared bus 103 is a common data bus to the first and second CPUs 101, 102. The shared memory 104 is made of a volatile semiconductor storage element to retain imaging parameters, decoding parameters, a read image, and a decoding result, and is typically a RAM (Random Access Memory).

The optical reading element 43 is made of, for example, a CMOS image sensor, which receives reflected light from the work to generate a read image. The image control circuit 105 is made up of an amplifier that amplifies an image signal from the optical reading element 43, an A/D converter that converts the image signal after the amplification to a digital signal, and the like, and controls the optical reading element 43, based on the imaging parameters inside the shared memory 104 such as, for example, exposure time, a gain, and the presence or absence of filter processing.

The DMAC (Direct Memory Access Controller: DMA controller) 111 transfers the read image generated by the optical reading element 43 from the imaging control circuit 105 to the shared memory 104 through the shared bus 103.

The network controller 106 is a communication circuit that communicates with external equipment such as the personal computer 3 through a LAN 112 (FIG. 1), and for example, is made of an EMAC (Ethernet Media Access Controller). The serial communication controller 107 is a communication circuit that communicates with external equipment through a serial communication interface, and for example, is made of a UART (Universal Asynchronous Receiver Transmitter).

The flash memory 108 is made of a nonvolatile semiconductor storage element to retain an image file, and for example, a detachable memory card such as an SD (Secure Digital, registered trademark) card is used. The input/output controller 110 controls writing and reading with respect to the image file in the flash memory 108.

When the network controller 106 or the serial communication controller 107 receives a reading start command to start the reading, the first CPU 101 instructs reading start to the imaging control circuit 105. The first CPU 101 also transfers the read image received from the optical reading element 43 to the shared memory 104.

The second CPU 102 makes up a decoding unit that reads the read image from the shared memory 104 to perform decoding processing, based on a decoding processing request from the first CPU 101. When the decoding processing ends in the second CPU 102, the decoding result is written in the shared memory 104.

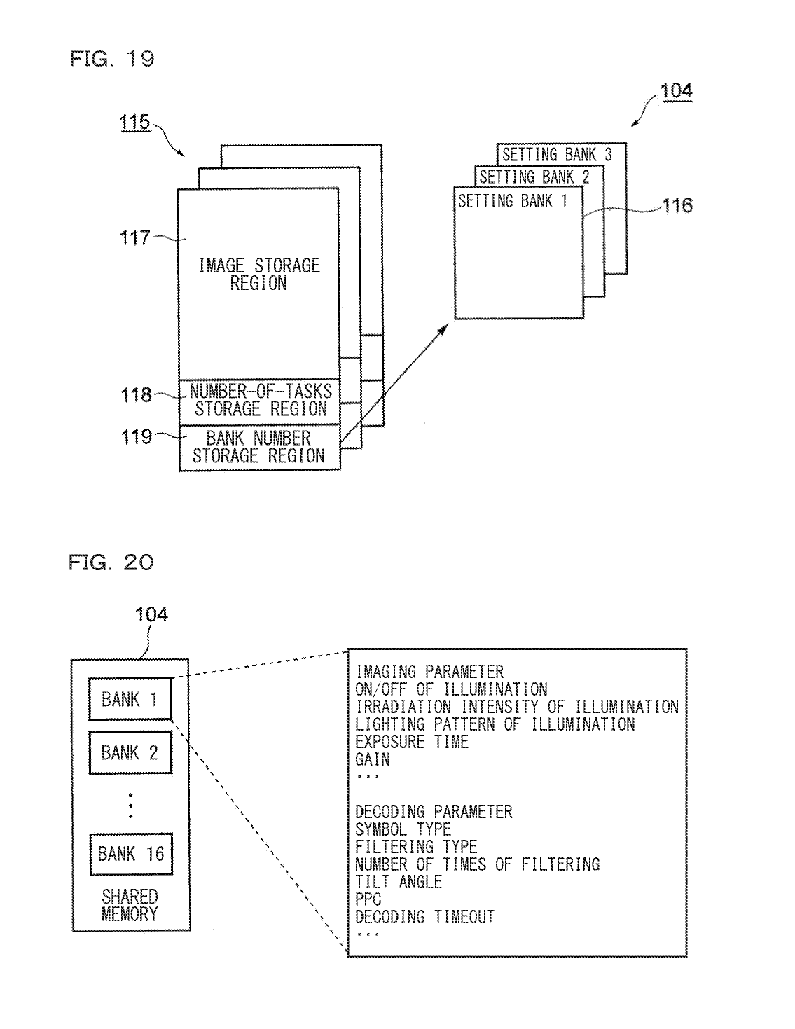

FIG. 19 is an explanatory diagram schematically showing one example of the operation of the bar code reader 2 in FIG. 18, in which setting banks 116 stored in image buffers 115 and the shared memory 104 are shown. The read image transferred into the shared memory 104 by the DMAC 111 is retained as the image buffer 115. Each of the image buffer 115 is made up of an image storage region 117 to retain the read image, a number-of-tasks storage region 118 to retain the number of reference tasks of the read image, and a bank number storage region 119 to retain a bank number specifying the setting bank 116 stored in the shared memory 104.

The read image is stored in the image storage region 117. The setting banks 116 each retain various settings such as the imaging parameters, the decoding parameters and the like. These imaging parameters and decoding parameters are set using the personal computer 3. The setting banks 116 each include the imaging parameters and the decoding parameters, as described above.

The plurality of setting banks 116 are stored in the shared memory 104 (FIG. 20), and these setting banks 116 are referred to by the first and second CPUs 101, 102, respectively. If the bar code reader 2 fails in the reading when the reading is executed based on one of the banks 116, the reading is tried based on the next bank 116, and if the bar code reader 2 also fails in the reading with the second bank 16, the reading is tried based on the next bank 116. In this manner, the switchover of the banks 116 is performed one after another until the reading succeeds.

A representative example of the setting parameters of an imaging system is as follows:
(1) ON/OFF of the illumination
(2) Irradiation intensity of the illumination
(3) Lighting pattern of the illumination
(4) Exposure time
(5) Gain
(6) Offset
(7) Dynamic range
(8) Taking-in range

A representative example of the setting parameters (decoding setting) of a reading system is as follows:
(1) Type of symbol (optical information)
(2) Filter type
(3) Number of times of filtering
(4) Tilt angle
(5) PPC
(6) Decoding timeout
(7) Taking-in range

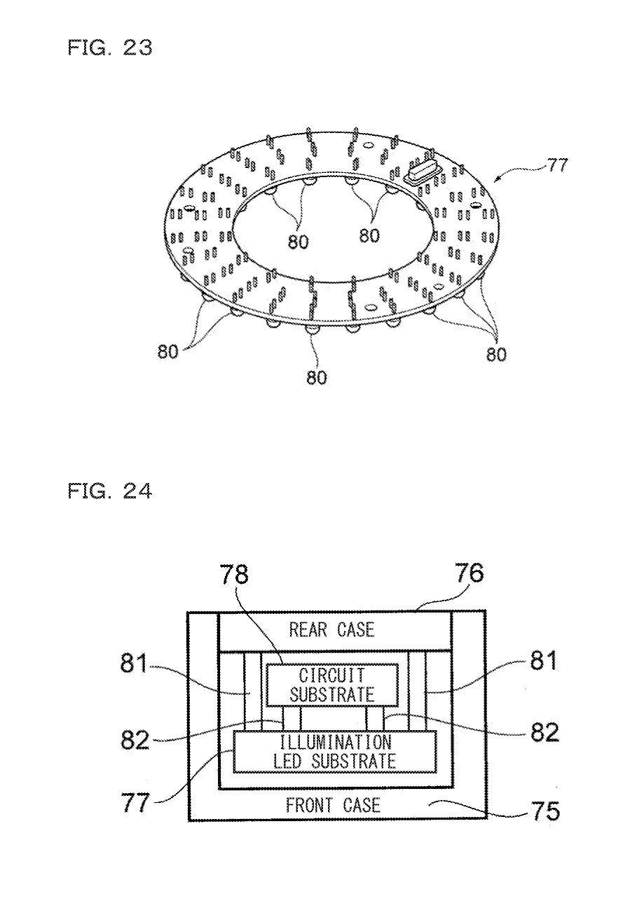

### Dedicated External Illumination Unit 4 (FIGS. 21 to 24):

FIG. 21 shows a state where the dedicated external illumination unit 4 is attached to the bar code reader 2, and reference numeral 70 denotes a cable connecting the bar code reader 2 and the external illumination unit 4. The power of the external illumination unit 4 is supplied from the bar code reader 2.

The external illumination unit 4 in a ring outer shape has a circular outline, and has a circular opening 4a in its center. The bar code reader 2 is positioned so that the center of the circular opening 4a matches the optical axis of the lens assembly 36 of the bar code reader 2. A stand 71 is prepared to position the bar code reader 2. As will be described in detail later, the stand 71 is made up of a pair of plate members 72 fixed to a back surface of the external illumination unit 4 by bolts, and attachment fittings 73 to fixedly set the bar code reader 2 at an arbitrary height position of the plate members 72.

First, a structure of the external illumination unit 4 will be described with reference to FIG. 22. FIG. 22 is an exploded perspective view of the external illumination unit 4. In the external illumination unit 4, an LED substrate 77 and a circuit substrate 78 are contained in an outer case made up of ring-shaped, cylindrical front case 75 and rear case 76 in a layered state with a stack connector 79 (FIG. 22) and first spacers 82 (FIG. 24) interposed therebetween.

The plurality of illumination LEDs 80 are installed in the ring-shaped LED substrate 77 having almost the same size as that of a ring cross-sectional shape of the ring-shaped, cylindrical front case 75. In the ring-shaped circuit substrate 78 preferably having almost the same size as the ring-shaped LED substrate 77, a CPU that controls the lighting of the plurality of LEDs 80 mounted on the external illumination unit 4, and controls communication with the bar code reader 2, and a memory M (FIG. 1) is installed in addition to an LED drive circuit. Referring to FIG. 24, obviously, the LED substrate 77 and the circuit substrate 78 are electrically connected, and the LED substrate 77 and circuit substrate 78 are fixed to each other by the first spacers 82, and the LED substrate 77 is fixed to the rear case 76 by second spacers 81. In other words, the circuit substrate 78 is fixed to the rear case 76 via the LED substrate 77.

For example, when a Fresnel lens (not shown) described later is employed in the front case 75, relative positioning between the illumination LEDs 80 of the LED substrate 77 and the front case 75 is important. In the example of FIG. 24, since the LED substrate 77 is positioned with respect to the front case 75 via the rear case 76, this not only allows the front case 75 and the LED substrate 77 to be relatively positioned, but also facilitates assembling work of the LED substrate 77 and the circuit substrate 78.

As a first modification, regarding a setting structure of the LED substrate 77 and the circuit substrate 78, instead of interposing the LED substrate 77, the circuit substrate 78 may be directly fixed to the rear case 76 via spacers. As a second modification, the circuit substrate 78 may be fixed to the rear case 76 via spacers, and the LED substrate 77 may be fixed to the circuit substrate 78 via other spacers.

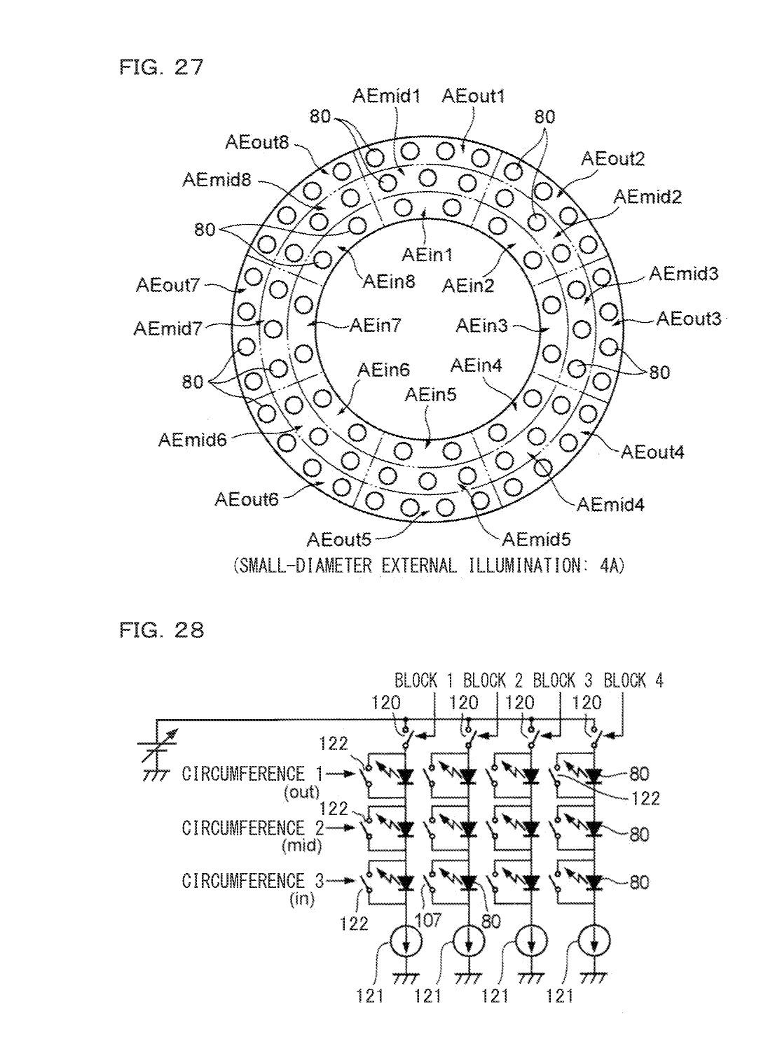

### Types of Dedicated External Illumination Unit 4 (FIGS. 26 and 27):

Two models of dedicated external illumination units 4 are prepared. FIG. 26 illustrates the LED substrate 77 of an external illumination unit 4B having a large diameter. FIG. 27 is a plan view of the LED substrate 77 of an external illumination unit 4A having a small diameter. These two types of illumination units 4 each have the CPU and the memory M, as described above. In the memories M, model information is stored, and when the external illumination unit 4A or 4B is connected to the bar code reader 2, the bar code reader 2 takes in the model information stored in the memory M of the external illumination unit 4 to thereby recognize the external illumination unit 4, by which the connection setting with the external illumination unit 4 is executed.

### Partial Illumination of Internal Illumination Unit 5 (FIG. 25):

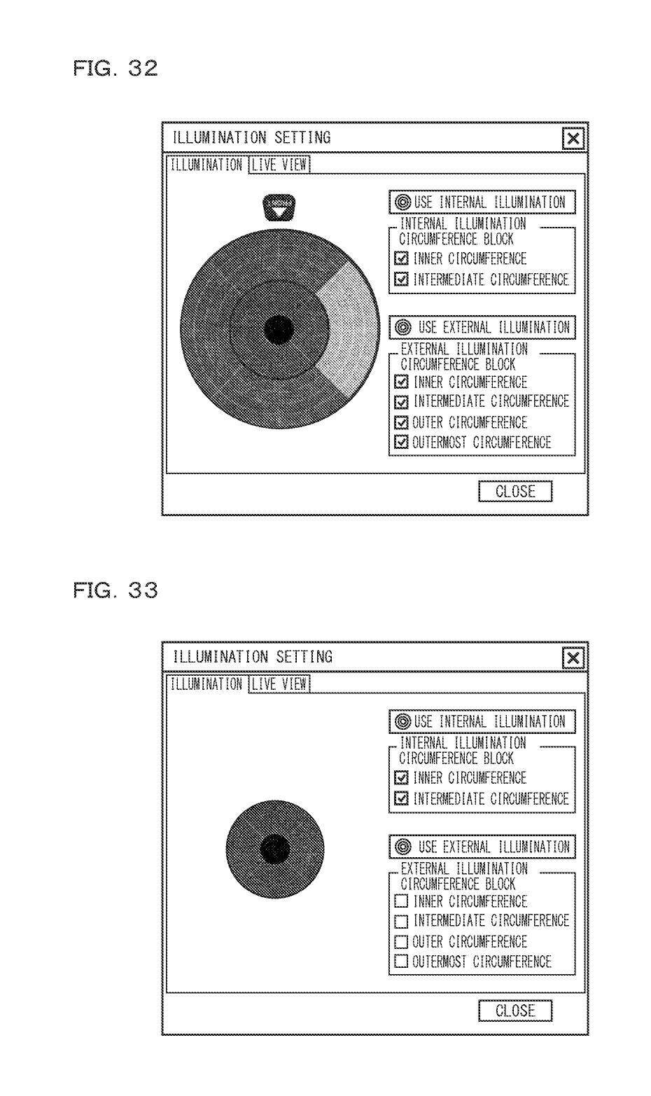

FIG. 32 is a plan view of the LED substrate 14 incorporated in the bar code reader 2. In the ring-shaped LED substrate 14, a large number of illumination LEDs 80 are arrayed almost uniformly in an entire circumference thereof. The illumination LEDs 80 are arranged at almost the same interval on three concentric circles at a distance from one another in a radial direction. More particularly, the plurality of illumination LEDs 80 are arrayed on the plurality of concentric circles different in diameter centering on the optical axis of the lens assembly 36 of the bar code reader 2.

In the ring-shaped LED substrate 14, partial illumination is performed, using, as a unit, each of a total of eight areas that are formed by dividing an entire area into four blocks at even intervals in a circumferential direction, and further dividing each of the blocks into two in the radial direction. Specifically, one row in an outermost circumference is divided into four areas at an interval of 90°. These areas are illustrated as an outer circumference first area AEout 1, an outer circumference second area AEout 2, an outer circumference third area AEout 3, and an outer circumference fourth area AEout 4. Two innermost and intermediate rows are divided into four areas at an interval of 90°. These areas are illustrated as an inner circumference first area AEin 1, an inner circumference second area AEin 2, an inner circumference third area AEin 3, and an inner circumference fourth area AEin 4. The LEDs 80 belonging to the respective areas of AEout 1 to AEout 4, and AEin 1 to AEin 4 are positioned so as to be distributed uniformly in the respective areas.

The illumination can be controlled, using each of the areas of the divided areas AEout 1 to AEout 4, and AEin 1 to AEin 4 of the internal illumination unit 5 as a unit. The lighting control by the division into these areas may include control of an amount of luminescence of the LEDs 80.

### Partial Illumination of External Illumination Unit 4B Having Large Diameter (FIG. 26):

On the ring-shaped LED substrate 77 of the external illumination unit 4B having the large diameter, a large number of illumination LEDs 80 are arrayed almost uniformly in an entire circumference. The illumination LEDs 80 are arranged at almost the same interval on four concentric circles at a distance from one another in a radial direction. More specifically, the plurality of illumination LEDs 80 are arrayed on the four concentric circles different in diameter centering on the optical axis of the lens assembly 36 of the bar code reader 2.

In the external illumination unit 4B having the large diameter, partial illumination is performed, using, as a unit, each of a total of 32 areas that are formed by dividing an entire area into eight blocks at even intervals in a circumferential direction, and further dividing each of the blocks into four in the radial direction. Specifically, in the ring-shaped LED substrate 77, a row in an outermost circumference is divided into eight areas at an interval of 45°. These areas are illustrated as an outer circumference first area AEout 1 to an outer circumference eighth area AEout 8. The next row is also divided into eight areas at an interval of 45°. These areas are illustrated as an outer intermediate first area AEmid 1 to an outer intermediate eighth area AEmid 8. The next row is also divided into eight areas at an interval of 45°. These areas are illustrated as an outer intermediate ninth area AEmid 9 to an outer intermediate 16th area AEmid 16. A row in an innermost circumference is divided into eight areas at an interval of 45°. These areas are illustrated as the inner circumference first area AEin 1 to an inner circumference eighth area AEin 8. The external illumination unit 4B having the large diameter can also be controlled, using each of a total of 32 areas as a unit. In the external illumination unit 4B as well, the control of the amount of luminescence of the LEDs 80 can be executed on the area basis.

### Partial Illumination of External Illumination Unit 4A Having Small Diameter (FIG. 27):

Referring to FIG. 27, on the ring-shaped LED substrate 77 of the external illumination unit 4A having the small diameter, a large number of illumination LEDs 80 are arrayed almost uniformly in an entire circumference. The illumination LEDs 80 are arranged at almost the same interval on three concentric circles at a distance from one another in a radial direction. More specifically, the plurality of illumination LEDs 80 are arrayed on the three concentric circles different in diameter centering on the optical axis of the lens assembly 36 of the bar code reader 2.

In the ring-shaped LED substrate 77, a row in an outermost circumference is divided into eight areas at an interval of 45°. These areas are illustrated as the outer circumference first area AEout 1 to the outer circumference eighth area AEout 8. An intermediate row is also divided into eight areas at an interval of 45°. These areas are illustrated as the outer intermediate first area AEmid 1 to the outer intermediate eighth area AEmid 8. A row in an inner circumference is also divided into eight areas at an interval of 45°. These areas are illustrated as the inner circumference first area AEin 1 to the inner circumference eighth area AEin 8. In the external illumination unit 4A having the small diameter, the partial illumination can also be set by dividing the entire area into a total of 24 areas. The lighting control by dividing the entire area into these areas may include the control of an amount of luminescence of the illumination LEDs 80. A color of the illumination by the illumination LEDs 80 may be varied, using each of the areas set for the partial illumination as a unit.

### LED Drive Circuit of External Illumination Unit 4 (FIG. 28):

FIG. 28 shows a part of the LED drive circuit. The illustrated LED drive circuit can light the LEDs 80 on the area basis, and can supply a constant current to the plurality of illumination LEDs 80 belonging to each of the areas.

For example, with the small-diameter external illumination unit 4A in FIG. 27, the eight areas resulting from circumferentially dividing the ring-shaped LED substrate 77 at the interval of 45° are referred to as “blocks”. For example, the outer circumference first area AEout 1, the intermediate first area AEmid 1, the inner circumferential first area AEin 1 make up a first block. In each of the blocks, a block switch 120 and a constant current circuit 121 are provided. Turning ON the block switch 120 brings a state where a voltage can be applied to the plurality of LEDs 80 belonging to the relevant block. For the plurality of LEDs 80 in each row, a row switch 122 to bypass the LEDs 80 is provided on the block basis, and a group of the illumination LEDs 80 connected parallel to each of the row switches 122 is connected in series. In FIG. 28, while only one of the illumination LEDs 80 is illustrated in each of the circumferential rows, this is only because the diagram is simplified, and it should be understood that a plurality of illumination LEDs 80 connected parallel to each of the row switches 122 are present in series.

The LEDs in each of the rows belonging to each of the blocks are connected in series, and in each of the rows, the row switch 122 is connected in parallel. Accordingly, turning OFF the arbitrary row switch 122 allows the constant current to be supplied to the plurality of LEDs 80 belonging to the relevant block and the relevant row. The external illumination unit 4A includes this LED drive circuit, by which the area of the partial illumination can be arbitrarily set, using each of the rows in each of the blocks as a unit. Moreover, by providing the constant current circuit 121 in each of the blocks, for example, a current flowing in the illumination LEDs 80 in the first to third circumferential rows in the same block can be maintained constant.

In other words, without the constant current circuit 121, for example, if the illumination LEDs 80 in the first circumferential row are switched from OFF to ON when the illumination LEDs 80 in the second and third circumferential rows are lighted, the voltage applied to the illumination LEDs 80 in the second and third circumferential rows will change, thereby changing the current flowing the illumination LEDs 80 in the second and third rows, and thus changing brightness.

In other words, even when the block switch 120 is turned ON/OFF, the amount of luminescence of the illumination LEDs 80 belonging to the other blocks does not change. This is because the respective blocks are connected to the power source in parallel. However, when the row switch 122 is turned ON/OFF, the number of the LEDs 80 lighted in the relevant block changes, so that the brightness of the LEDs 80 changes with this.

When the lighting pattern of the partial illumination is set, fluctuation factors of the brightness of the LEDs 80 are desirably eliminated as much as possible in view of searching an optimal way to throw the light to the work. For this reason, the constant current circuit 121 is provided in each of the blocks. Thereby, when setting work of the lighting pattern is performed, it becomes easier to find the optimal lighting pattern by assuring uniformity and constancy of the luminance of the LEDs 80 in the lighted area to perform the partial illumination when the lighting pattern is changed. For the external illumination unit 4B having the large diameter, and the internal illumination unit 5, the LED drive circuit in FIG. 28 can be similarly employed.

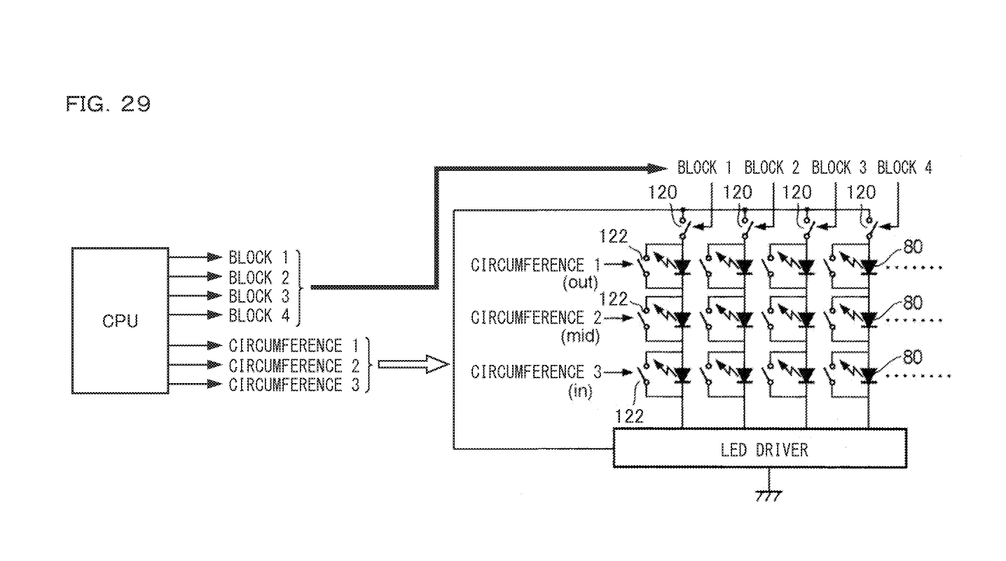

### Partial Illumination of Internal Illumination Unit 5 and External Illumination Unit 4 (FIG. 29):

The internal illumination unit 5 and the external illumination unit 4 are both surface light sources with the plurality of LEDs arrayed two-dimensionally, and these surface light sources can be each divided into several areas circumferentially and radially to perform partial illumination, using each of the areas as a unit, and the lighting pattern indicating which area is to be lighted and which area is not to be lighted can be arbitrarily set by the user. The lighting pattern including the lighting in all the areas can be registered by the user using the PC 3, and the lighting pattern set by the user is stored in the memory M of the bar code reader 2, and in the memory M of the external illumination unit 4 when the external illumination unit 4 is connected. This lighting control includes the control of the amount of luminescence of the illumination LEDs 80. In FIG. 29 as well, similarly to FIG. 28, while only one of the illumination LEDs 80 is illustrated in each of the circumferential rows, this is only because the diagram is simplified, and it should be understood that a plurality of illumination LEDs 80 connected parallel to each of the row switches 122 are present in series.

As described with reference to FIG. 1, the external illumination unit 4 includes a control unit of the CPU. Accordingly, as illustrated in FIG. 29, the respective block switches 120 and the row switches 122 in the respective circumferential rows are controlled by the CPU of the external illumination unit 4, so that when the circumferentially and radially divided partial illumination areas are set, the lighting control of the LEDs 80 is executed, using each of these areas as a unit.

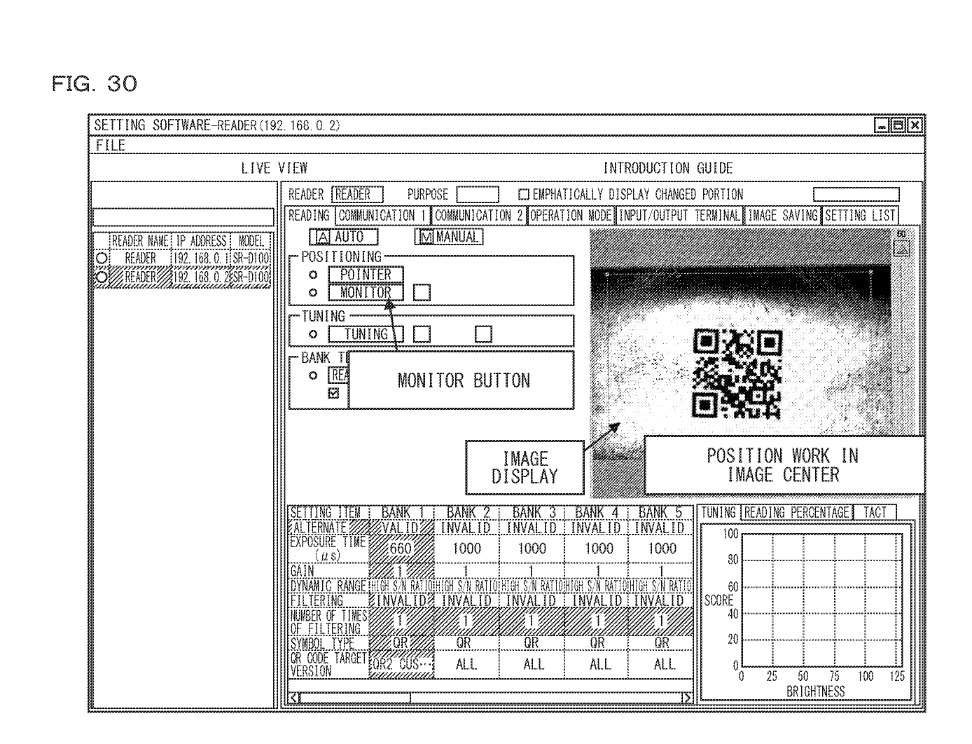

### User Interface (FIGS. 30 to 38):

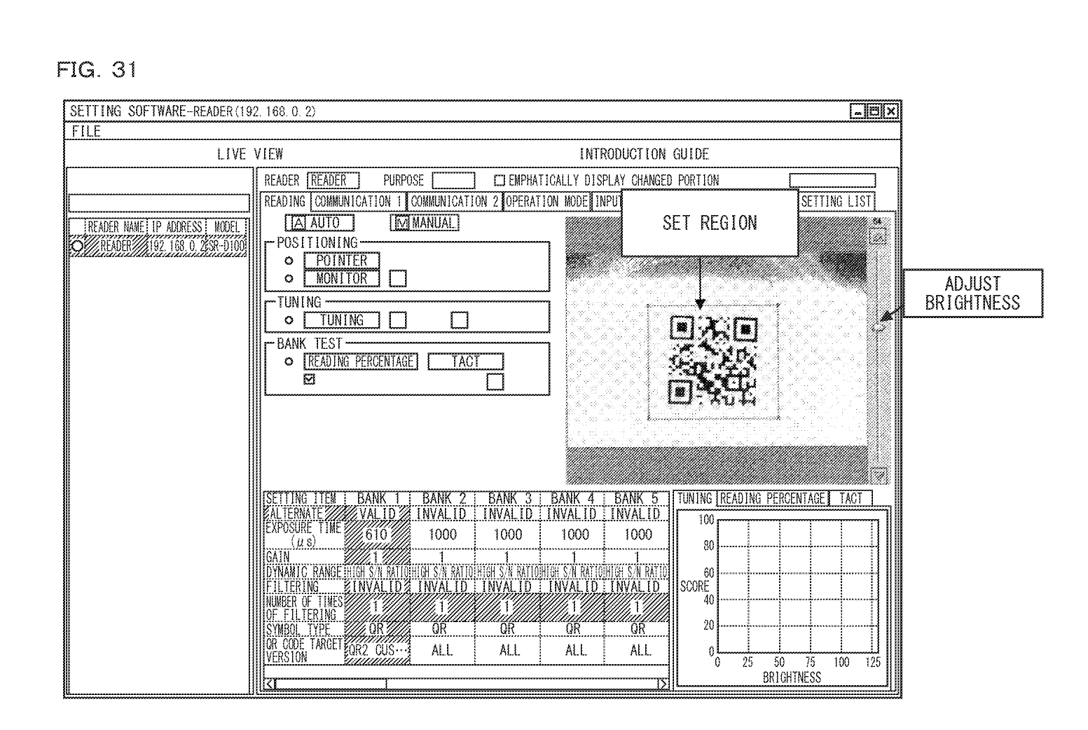

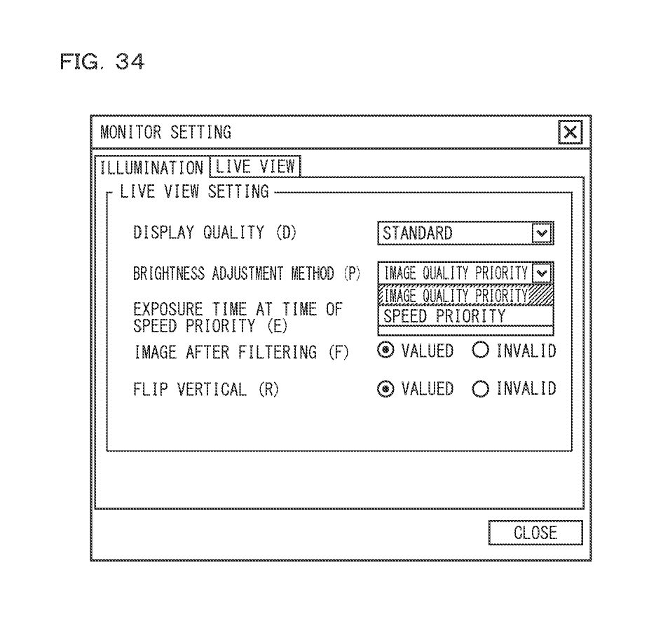

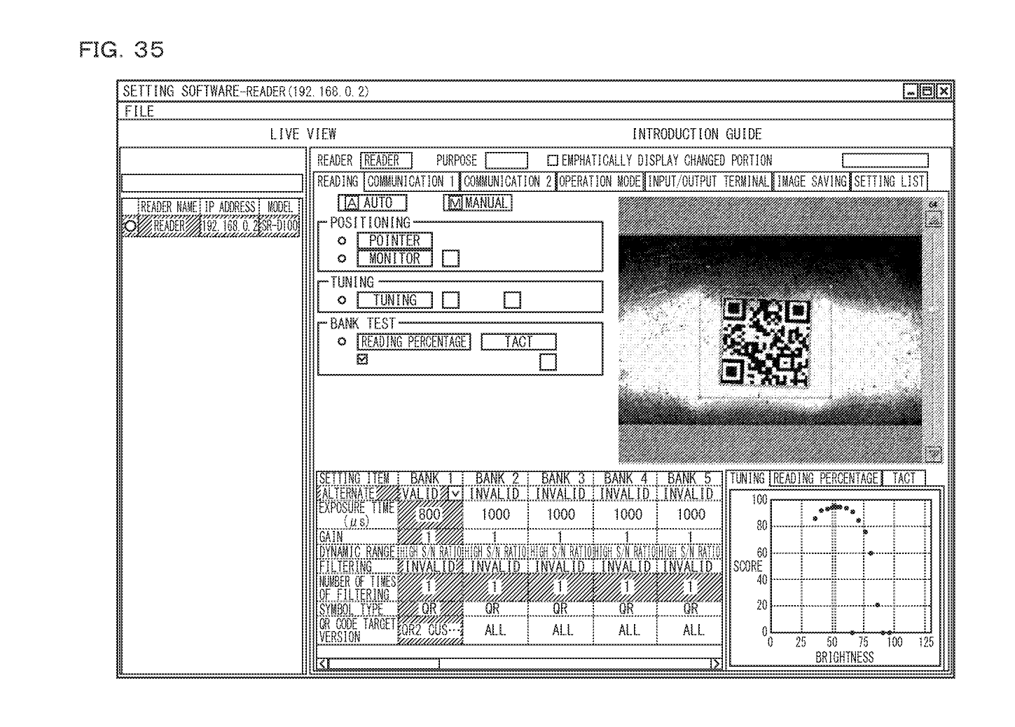

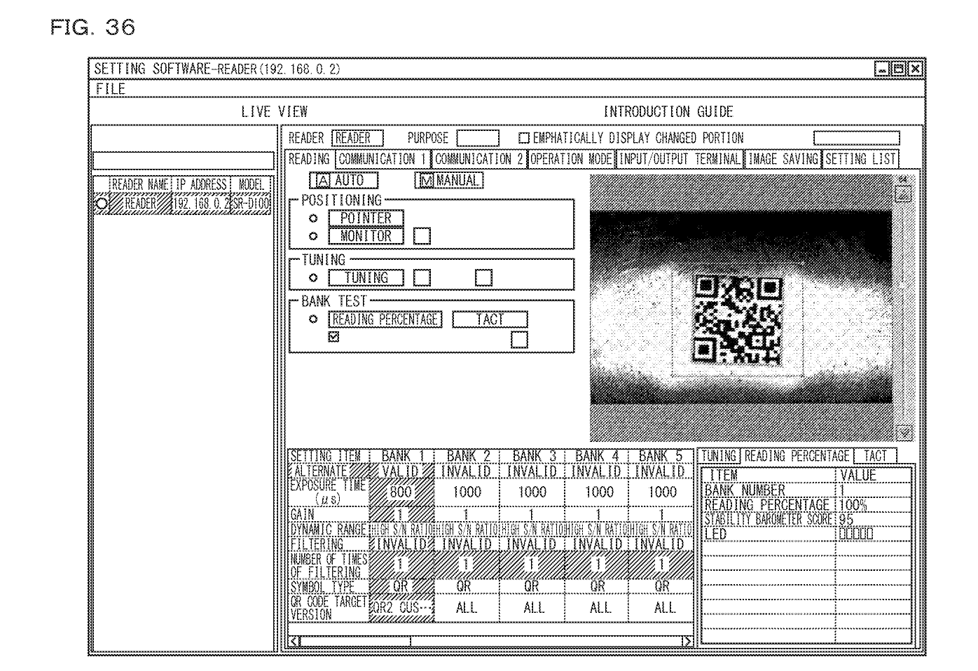

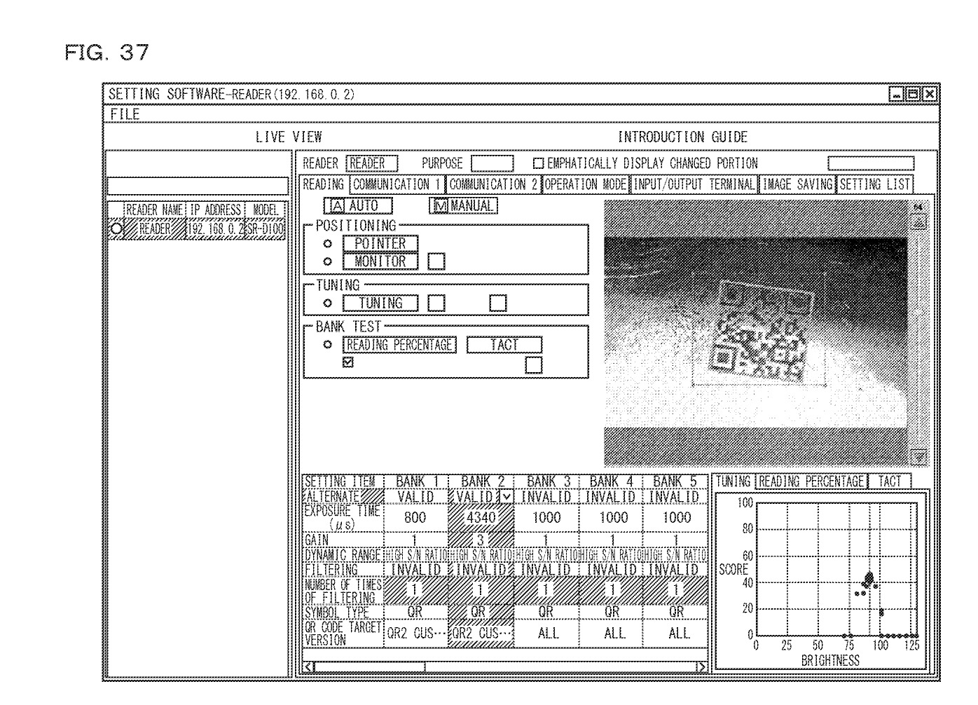

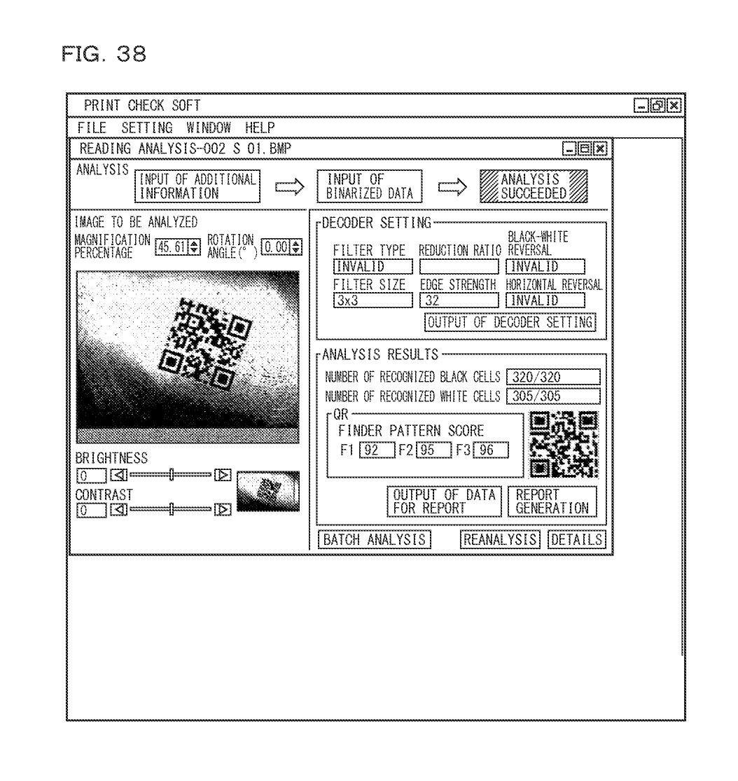

FIGS. 30 to 39 show user interface screens displayed on a display of the personal computer 3 as the external terminal. Referring to FIGS. 30 to 39, an outline of the operation procedure of the bar code reader system 1 will be described. The work is executed in the following order.
(1) The user positions the work (FIG. 30).
(2) The user sets an optical information reading region while viewing the display of the picked-up image, and adjusts the brightness of the optical information reading region (FIG. 31).
(3) The user sets the lighting pattern of the internal illumination unit 5 and the external illumination unit 4 (FIGS. 32 and 33).
(4) The user sets tuning (FIG. 34).
(5) Tuning processing is executed (FIG. 35).
(6) Reading trial is started (FIG. 36).
(7) As needed, the bank storing the various setting parameters for reading the optical information is added (FIG. 37).

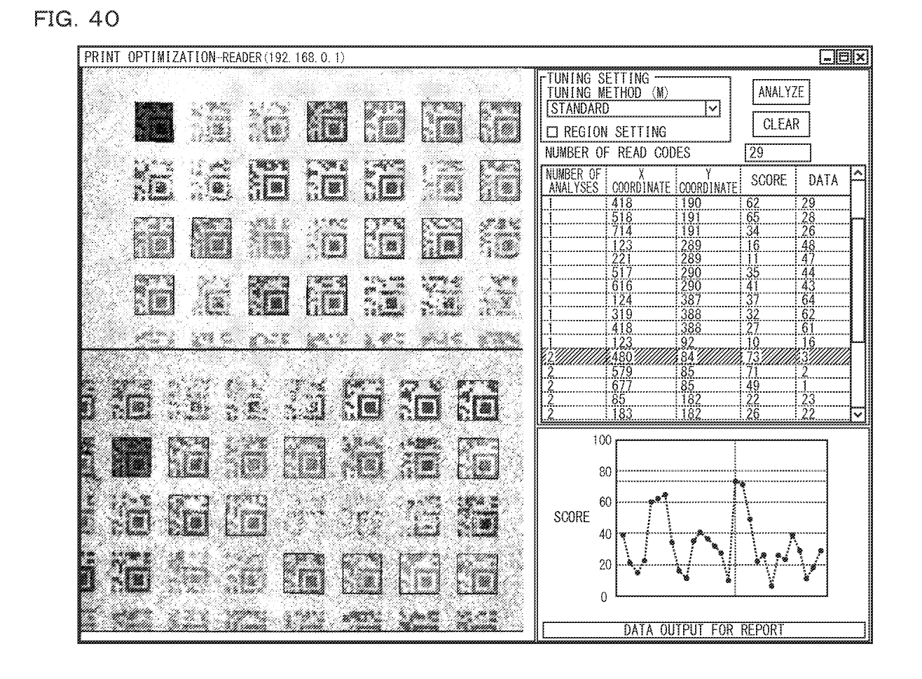

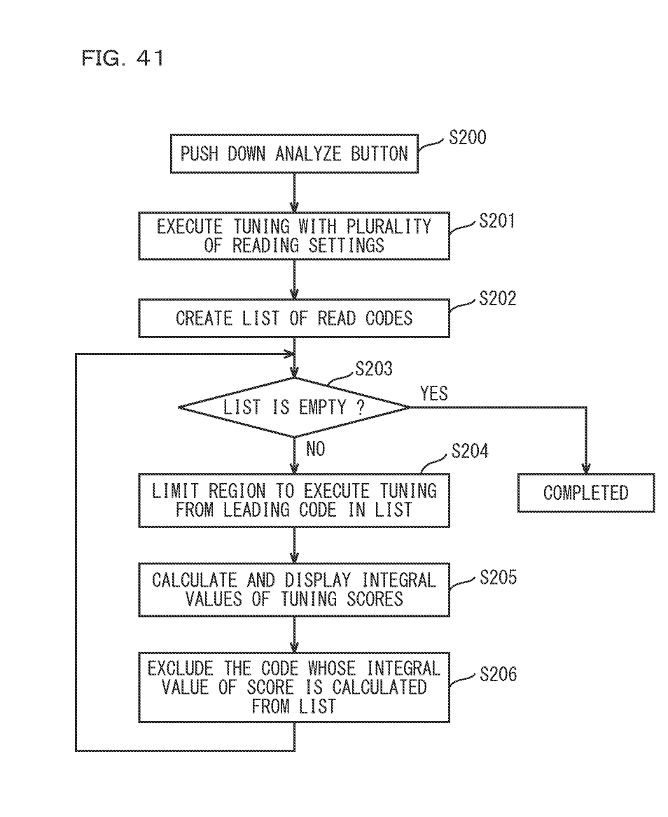

As the imaging parameters included in each of the banks, the ON/OFF of the illumination, the illumination intensity, the lighting pattern of the illumination, the exposure time, the gain, the taking-in range of the picked-up image and the like are included, and as the decoding parameters, the type of the optical information (bar code, QR code, or the like), the type of filtering, the number of times of filtering processing, the decoding timeout time, the taking-in range, and the like are included.
(8) An image that cannot be read (NG image) is analyzed (FIG. 38, FIGS. 40 and 41 described later).

### (First Work) Positioning of the Work (FIG. 30):

First, the connection setting between the personal computer (PC) 3 and the bar code reader 2 is performed. At this time, the connection setting can be easy and conveniently performed by assigning a tentative IP address. When the dedicated external illumination unit 4 is connected to the bar code reader 2, the model information of the relevant external illumination unit 4 stored in the memory M (FIG. 1) of the external illumination unit 4 is read, which allows the connection setting of the external illumination unit 4 to be automatically executed, based on the model information registered in advance in the memory M (FIG. 1) of the bar code reader 2.

Next, the pair of LEDs for pointer 40 incorporated in the bar code reader 2 is lighted and the work is placed within the visual field range of the bar code reader 2. The user positions the work while viewing the picked-up image displayed in the display screen (in the user interface screen) in FIG. 30. The user interface screen has a monitor command button, so that when the user pushes down the monitor command button, an imaging command signal is transmitted from the personal computer 3 to the bar code reader 2, and the image picked up by the bar code reader 2 is inputted to the personal computer 3 to be displayed in the user interface screen. Since the imaging by the bar code reader 2 is continuously executed, the picked-up image displayed in the user interface screen is a moving image display. The user performs the positioning of the work so that the optical information, generally the bar code or the like, is located in a center of the picked-up image while viewing the live image. That is, the user can adjust a relative position of the work to the bar code reader 2 while checking the live image displayed as a moving image on the display of the personal computer 3.

### (Second Work) Setting of Optical Information Reading Region and Adjustment of Brightness (FIG. 31):

Referring to FIG. 31, region setting is performed to the picked-up image in an image display frame of the user interface screen. This is enabled by operating a range specification frame displayed in a superimposed manner on the picked-up image, and the rectangular optical information such as the bar code in the picked-up image is surrounded to specify the region (FIG. 31), by which the optical information reading region can be set. The brightness in the specified optical information reading region can be set by the user operating a slider on a bright adjustment bar at a right end of the user interface screen. This brightness after adjustment is utilized as an initial value of the tuning.

### (Third Work) Setting of Lighting Pattern (FIGS. 32 and 33):

The setting of the lighting pattern can be performed by calling a lighting pattern setting screen in FIG. 32 or FIG. 33. This setting screen of FIG. 32 or FIG. 33 is displayed in a superimposed manner on the user interface screen described above. FIG. 32 is the setting screen when the dedicated external illumination unit 4 is connected to the bar code reader 2, and FIG. 33 is the setting screen when the dedicated external illumination unit 4 is not connected. As seen from comparison between FIGS. 32 and 33, when the dedicated external illumination unit 4 is connected (FIG. 32), the schematic diagram of the illumination unit expressing the respective areas of the dedicated external illumination unit 4 and the respective areas of the internal illumination unit 5 in a ring shape similar to these units 4 and 5 is displayed. When the external illumination unit 4 is unconnected, the schematic diagram of the illumination unit limited to the internal illumination unit 5 is displayed. That is, for each of the illumination units used for the illumination of the bar code reader 2, the schematic diagram corresponding to each of the illumination units is displayed in the pattern setting screen.

The schematic diagram displayed in the setting screen of FIGS. 32 and 33 includes the above-described partial illumination areas AE (e.g., FIG. 27), and the user can select the arbitrary area to set the illumination area. When the user selects the lighting area in the schematic diagram, a display color of the selected area is changed, for example, from gray to red, which enables the user to recognize which area is specified as the lighting area at glance. In the example of FIG. 32, all the areas of the internal illumination unit 5 are set as the lighting areas, and on the other hand, as for the external illumination unit 4, a state where the areas other than the right area are set as the lighting areas is shown. In the example shown in FIG. 33, where the external illumination unit 4 is unconnected, a state where all the areas of the internal illumination unit 5 are set as the lighting areas is shown. In the lighting area setting screen in FIGS. 32 and 33, when the user changes the lighting area, the color display of the corresponding area in the schematic diagram of FIGS. 32 and 33 is converted in real time. In this manner, since the image picked up in each of the lighting patterns is updated and displayed on the display in real time, the user can easily select the desired lighting pattern while viewing the picked-up image. For the live image in real time, the amount of light, the exposure time, the gain, and the like of the illumination are feedback-adjusted so that an average value of the brightness in the brightness setting region decided in advance becomes the brightness adjusted by the user sliding the above-described brightness adjustment bar at the right end of the user interface screen. This enables the image display while keeping constant the brightness in the region that the user is interested in, even if the lighting pattern is changed.

Regarding the setting of the partial illumination, in place of selecting the lighting area using the diagram display imitating the illumination units as described above, the plurality of lighting patterns registered in advance by the user may be displayed in a list, and the user may select the lighting pattern from these plurality of lighting patterns.

### (Fourth Work) Tuning Processing (FIG. 34):

FIG. 34 is a tuning setting screen, which is displayed in a superimposed manner on the user interface screen described with reference to FIG. 30 and the like. Utilizing this setting screen in FIG. 34, (1) an image priority mode and (2) a speed priority mode can be selected alternatively.

### (Fifth Work) Tuning Processing (FIG. 35):

First, the bank whose setting the user wants to change by the tuning is selected, and the tuning processing is executed. Referring to FIG. 35, the region setting is performed to the picked-up image in the image display frame in the user interface screen. This can be performed by operating the range specification frame displayed in a superimposed manner on the picked-up image, and the rectangular optical information such as the bar code in the picked-up image is surrounded to specify the region (FIG. 35), by which a tuning target region can be set.

The optical information is extracted from the tuning target region set by the user. For the change in brightness made by the tuning processing, the brightness set in the processes of the setting of the optical information reading region and the adjustment of the brightness (FIG. 31) is used as the initial value. Obviously, the brightness may be changed from an initial value arbitrarily set by the user in advance, or a lower limit value or an upper limit value in a range of the brightness change in the tuning processing may be used as an initial value.

When the decoding of the optical information extracted from the tuning target region succeeds, a profile of the optical information is brought into a display state surrounded by a green frame. The appearance of this green frame allows the success of the decoding to be recognized at a glance. If the decoding never succeeds even when the various values of the parameters of the brightness, the decoding condition, the lighting pattern, and the like are changed with the tuning, it is processed as “tuning failure”.

The user interface screen includes display of a tuning score at the bottom right in FIG. 35. In this display, a horizontal axis indicates the brightness, and a vertical axis indicates a score. The value of the parameter when this tuning score becomes the highest is set in the above-described bank.

### (Sixth Work) Image Reading Trial (FIG. 36):

The bank that the user wants to use to try the reading of the optical information is selected, and a “reading percentage” button is pushed down, which allows a reading test to be executed. A result of the trial of the reading is displayed at the bottom right of the user interface screen in FIG. 36, and the display of this reading result includes “%” and a “score”.

### (Seventh Work) Bank Addition (FIG. 37):

When precise operation of the bar code reader system 1 is difficult with the plurality of banks already set, for example, in situations where the setting condition is not even, the reading is not stable, and so on, bank addition is performed. In an example in FIG. 37, selecting a bank 1 and a bank 2 automatically generates a bank of the brightness between the bank 1 and the bank 2. For the parameters other than the brightness of the bank newly generated, the parameters of the bank 1 are copied as they are. The above-described tuning may be executed for this automatically generated bank to optimize the values of the parameters other than the brightness.

### (Eighth Work) Analysis of NG Image (FIG. 38, and FIGS. 40, 41 Described Later):

An image that cannot be read is read again from the bar code reader 2, and the decoding condition is optimized (tuned). If the reading succeeds by the tuning of the decoding condition, a color of a success display field in FIG. 38 is reversed. When the reading succeeds, the decoding condition under which the reading succeeds can be saved, and a report of a print quality evaluation result can also be outputted by the user pushing down a “decoding setting output” button. While this analysis of the NG image is executed by an NG image analysis program, which is central to conducting this analysis, it may be conducted by the setting program described above.

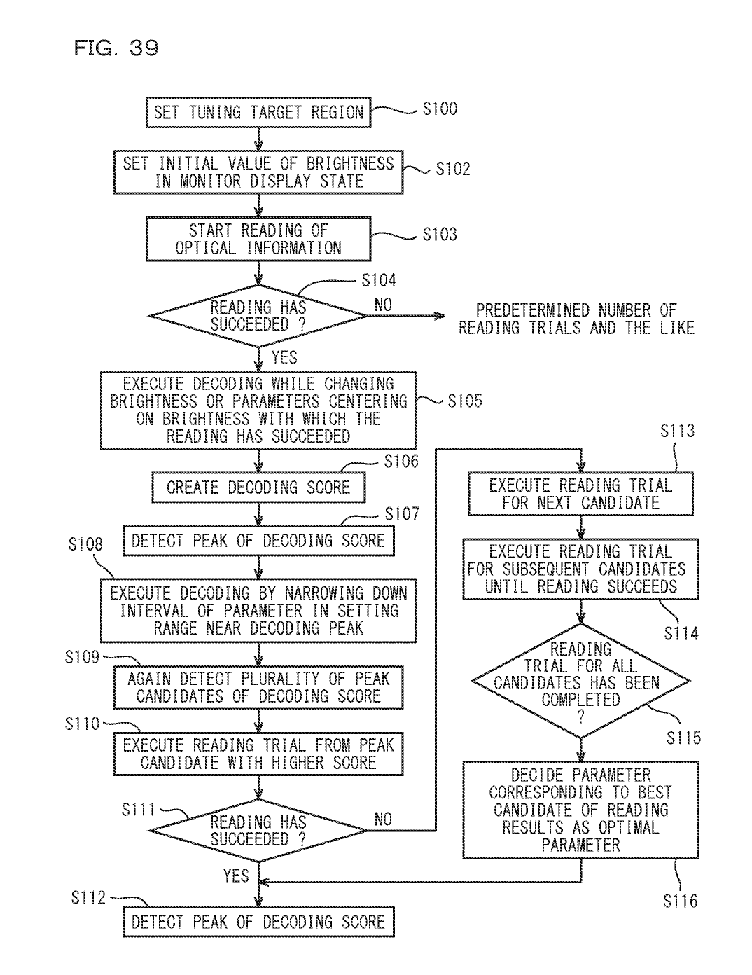

### Specific Example of Tuning (FIG. 39):

The tuning processing (FIG. 35), which is the fifth work, is used for the setting of the various parameters of the bar code reader system 1. Referring to FIG. 39, the setting of the tuning target region is first performed in step S100. This setting of the tuning target region narrows down the reading range of the picked-up image. The tuning target region can be set at the center of the picked-up image displayed in the user interface screen, or can be set even at the corner of the picked-up image. That is, the setting of the tuning target region can be arbitrary made by the user, corresponding to a position where the optical information exists. The tuning target region is set in a limited way to a size of the optical information, which can increase the reading speed of the image, thereby contributing to an increase in tuning processing speed.

In the next step S101, the setting of the initial value of the brightness of the picked-up image displayed in the user interface screen is performed. As the initial value, the brightness obtained by the adjustment of the brightness of the optical information reading region (FIG. 31), which is the second work, is employed. By using, as the initial value of the tuning, the brightness set as an optimal value by the brightness adjustment performed in a pre-stage of the tuning, the generally optimal brightness can be set at an initial stage of the tuning. This can drastically shorten tuning processing time.

In the next step S102, the reading of the tuning target region is started with the brightness of the initial value, and if the reading has succeeded, the type, the size, and the display position of the optical information are acquired, and the processing proceeds from step S104 to step S105. In step S105, most preferably, the brightness with which the reading has succeeded is set as the initial value, and the decoding of the optical information is executed while changing the values of the brightness and the other parameters, centering on the brightness of the initial value. Obviously, brightness within a predetermined range including the brightness with which the reading has succeeded may be set as the initial value, or the decoding may be executed while changing the brightness in the predetermined range including the brightness of the initial value, and the other parameters. The parameters to be changed in the tuning processing are exemplified as follows.
(1) Brightness of the image
(2) Filtering
(3) Contrast of the image
(4) Curved surface setting

The above-mentioned (4) curved surface setting means the setting of the parameter suitable for the reading of the optical information given to a curved surface, for example, when the work is a columnar body.

In many cases, since the initial value of the brightness is the brightness set as the optimal value in the preceding processing, a percentage of the determination of the reading success in step S104 should be very high. Moreover, reading success on the first trial using the initial value of the brightness enables the information of the type, size, and position of the optical information such as the bar code and the QR code to be acquired at the initial stage of the tuning processing, and the information directly related to the optical information is reflected on the decoding processing in the next step S105. This allows the decoding to be ended with ease and in a short time. That is, when the reading succeeds for the first time, the information of the type, size, and position of the optical information is acquired, and this acquired information is reflected on the decoding processing.

The result (score) of the decoding executed in step S105 is calculated in the next step S106. Referring to this score, a rough indication of the value of the parameter suitable for the setting can be obtained.

In the next step S107, the highest score is detected from the plurality of decoding scores, and subsequently in step S108, the decoding is executed while sequentially changing the value of the parameter by narrowing down an interval of the change of the value of the parameter, in a range near the value of the parameter when the decode score is the highest, so that the results (scores) are created.

The results with the higher scores are detected from the decoding results (scores) as a plurality of candidates (S109), and the reading is executed with the candidate with the highest score of the plurality of candidates (S110), and if the reading has succeeded, the “tuning success” is determined, and the value of the parameter corresponding to this best candidate is decided as the value of the optimal parameter (S111, S112).

In many cases, it is considered that the tuning succeeds with the brightness of the initial value, that is, the optimal brightness set in the work before the tuning. Moreover, the reading is started by narrowing down a range to the tuning target region, which is a partial region of the picked-up image (S103). The percentage of the success of the reading is generally high, and the information of the position, size, and type of the optical information is acquired by the reading, which enables the subsequent tuning processing to be executed quickly, thereby largely shortening time required for the tuning.

The processing returns to step S104 in FIG. 39, in which if the reading has failed with the brightness of the initial value, the reading is tried while changing the brightness centering on the brightness of the initial value. When the reading fails even if the reading is executed a predetermined number of times, “tuning disabled” is determined to end the tuning processing.

Moreover, if the reading has failed in step S111 in FIG. 39, the processing proceeds to step S113 to try the reading with the next candidate, and if the reading has succeeded, the value of the parameter corresponding to the second candidate is decided as the value of the optimal parameter (S116).

If the reading with the second candidate has failed, the reading with the third candidate is executed, and similar processing is executed with all the candidates until the reading succeeds (S115), and the value of the parameter corresponding to the candidate with which the reading has succeed is decided as the value of the optimal parameter (S116).

As described above, referring to FIG. 39, the specific example of the tuning has been described. The brightness is set in connection with the exposure time and the gain. When the exposure time becomes longer, there is a possibility that image blur is caused by movement or vibration of the work, thereby disabling the reading. In order to address this problem, it is preferable to shorten the exposure time. However, when the exposure time is shortened, the gain needs to be increased in accordance with this, and on the other hand, when the gain is set higher, there will be caused a next problem that a noise component of the image is increased. That is, the three of the brightness, exposure time, and gain have the following relationship.

(Brightness)=(exposure time)×(gain setting)

In view of the foregoing, in the tuning setting screen, the user is enabled to select between “image quality priority” and “speed priority” (FIG. 34).

In the “image quality priority” mode, for the exposure time, an upper limit value is set to 5 ms, and the maximum gain is limited up to 2 fold. In the “speed priority” mode, for the exposure time, the upper limit is the time set in advance, and the maximum gain is 5.4 fold.

Regarding the lighting pattern, it is preferable to enable the plurality of lighting patterns to be registered, and the initial value of the brightness setting is preferably prepared for each of the registered lighting patterns.

If determined as NO, that is, “reading failure” in steps S104 and S111, and the reading is disabled even though the reading trial is executed several times, the tuning of the parameters of the reading system (decoding setting) may be performed. The same is true when the reading becomes unstable during operation of the bar code reader 2. That is, when a “reading error” occurs during the operation of the bar code reader 2, the picked-up image when the reading error occurs is transferred to the personal computer 3, and by using this picked-up image, the parameters of the reading system are optimized by the personal computer 3 to reflect the optimized parameters on the operation of the bar code reader 2.

### Code Quality Evaluating Program (FIGS. 40 to 42):

In the personal computer 3, a code quality evaluating program is installed. In the following, an outline of the code quality evaluating program will be described. First, a conventional way will be described. The optical information is processed or inscribed on the work by the marker. Taking as an example a laser marker that inscribes the code, that is, the optical information on the work, using laser light, good or poor (readability) of the code by the laser marker is decided by the eyes of the user. That is, when the processing condition of the laser marker is set, the plurality of codes are inscribed on a test piece of the work while changing the processing condition, using a sample processing function included by the laser marker, and the plurality of codes on this test piece are evaluated to set the processing condition of the code considered to be optimal in the laser marker. Conventionally, this evaluation has been left to the visual check by the user.

In general terms, it is known that with the code (the optical information such as the bar code and the QR code) inscribed directly to the work, called the direct part marking, and the code of the work including a fine grinding trace on a surface, called hairline work, that is, the optical information, a success percentage of the reading of the bar code reader varies depending on the way to throw the light and the like.

Accordingly, even if the user determines that the code is optimal by viewing, it is not necessarily optimal for the reading of the bar code reader in connection with the illumination. Moreover, even if the user considers that it makes no difference which any one of two prints is to be selected, there may be a difference in the reading of these two codes in terms of the reading of the bar code reader, particularly in the stability of the reading. On the operation of the bar code reader, it is generally rational to select the code with high reading stability of the bar code reader. As setting parameters of the laser marker, there are typically (1) a scanning speed of the marker and (2) laser output, and an increase in scanning speed will increase a processing speed of the work.

The personal computer 3, which has the code quality evaluating program installed, functions as a code quality evaluating apparatus. The code quality evaluating apparatus takes in picked-up images from the bar code reader 2, in which the codes inscribed on the test piece of the work by the laser marker are imaged under a common imaging condition. The readable codes are extracted from the picked-up images to evaluate the extracted codes.

When the plurality of codes are inscribed on one test piece, positions of the respective codes are specified from the picked-up images, and the reading trial is performed while changing the brightness in each of the codes. Moreover, when one code is inscribed on one test piece, a position of this one code is specified, and the reading trial is performed while changing the brightness.

The evaluation of the code is intended to present a level of the reading stability from the standpoint of the bar code reader 2 to the user as the score, which is easy for the user to understand. The code quality evaluating program compares the plurality of codes that the laser marker inscribes while changing the processing condition by the sample processing function, after the reading trial is performed under the setting condition on the bar code reader 2 side, and presents the evaluation to the user in the score, which is objective and easy for the user to understand. For the score, the highest value of a barometer of the “readability” is not employed, but the form of the score indicating the reading stability obtained by trying the reading in the plurality of setting conditions is preferably employed. As the score, a value of integral (an area) of the barometer of the readability is preferably employed, by which information of whether or not the code is unreceptive to the change in illumination condition, that is, can be stably read even if an illumination condition changes, can be presented to the user. The barometer of the “readability” is comprehensively calculated by combining contrast of the image, an error correction percentage (a rate of correction when codes partially blurred and codes partially contaminated are read), whiteness and blackness levels of cells, and the like.

FIG. 40 is a user interface screen of the code quality evaluating program. When the processing test is conducted by the laser marker, as described above, there are a case where the code processing is performed at a plurality of portions on one test piece, and a case where the code processing is performed on a plurality of test pieces. Moreover, when the imaging is performed by the bar code reader 2, the illumination condition may vary depending on the portion of the code. In view of the foregoing, the code quality evaluation program is produced. Specifically, the picked-up images by the bar code reader 2 are taken in to create a list of the readable codes from these picked-up images, and images of these readable codes are displayed in the list (FIG. 40). The tuning processing is performed to all the listed-up codes. In this tuning processing, the reading is tried while changing the brightness, and the barometer of readability is found in each of the reading trials, the scores indicating the reading stability are calculated based on the values of integral of the barometer, and the scores are displayed as numeric values or in a graph. In each of the listed-up codes, an order at the time of the sample processing is buried.

Referring to a flowchart in FIG. 41, a processing procedure will be described. First, in step S200, when an analyze button prepared in the user interface screen in FIG. 40 is pushed down, in the next step S201, the picked-up images of the codes on the test piece, which are imaged under the setting condition of the bar code reader 2, are taken in, and all the readable codes are extracted while changing the brightness to the taken-in picked-up images. As to the extraction of the codes, since the codes are extracted while changing the brightness, all the codes readable by the bar code reader 2 under various environments can be extracted. In step S202, the list of the extracted codes is created. Moreover, the images of the extracted codes are displayed in the user interface screen (FIG. 40).

In the next step S203, whether or not the list is empty is determined. In this case, it is determined as NO since the plurality of codes are present in the list, and the processing proceeds to step S204, in which, after limiting the reading region to a size of the relevant code, the tuning processing is executed from the leading code in the list. In this tuning processing, the trial of the reading is performed while changing the brightness, and the barometer of the readability is found in each of the reading trials to calculate the score indicating the reading stability, based on the value of integral of this barometer. In accordance with a print order of the codes corresponding to the relevant code, that is, the print order of the sample prints, the above-described scores are displayed in the user interface screen in FIG. 40 in forms of numeric values and a plot of a graph in association with the images of the corresponding codes (S205).

The code for which the tuning has been completed in step S205 is excluded from the list, the processing in steps S204, S205 is sequentially executed for the subsequent codes until the processing for all the listed codes has been completed.

On the right side of the user interface screen in FIG. 40, a list of analysis results (numeric values) of the respective codes is displayed, beneath which the barometers of the respective codes are displayed in the plot form of the graph. In a horizontal axis of this graph, the codes are indicated in the order at the time of the sample prints. A vertical axis indicates the score. The code with the highest score means that the relevant code has large reading stability. That is, as the score is higher, the receptivity to the change in the illumination light is lower, which means that a possibility that the reading is disabled by change in the way to throw the illumination light is lower. From this level of the score, it is known whether or not the code can be stably read. Moreover, as to the list of the images of the codes displayed on the left side, the sample processing is executed in order from top left, and viewing a position of each of these codes allows a level of the scanning speed of the marker to be recognized. Accordingly, when the user gives priority to the processing speed of the laser maker, for example, when the code are listed in order from the faster scan speed, the user will select the candidate code as close to the top left as possible. For example, when the plot of the graph of the desired score is selected, the code image (in a left portion of the screen) and the score in the numeric display (in an upper right portion of the screen) corresponding to this selected score are emphatically displayed in conjunction with this. For example, when the reading stability of the bar code reader 2 is valued, and a peak in the graph, which is the highest score, is selected, the numeric score and the image of the code related to this are highlighted, which makes it easy for the user to identify the code image and the numeric value related to this.

Moreover, as can be understood from the user interface screen in FIG. 40, a portion where the list of the images of the codes are displayed can be separated into a plurality of screens. Therefore, a plurality of code groups, that is, the code groups resulting from imaging the codes processed on the test pieces of the work, which are different from one another, can be displayed simultaneously, which allows the user to select the code that the user determines to be optimal across the plurality of code groups.

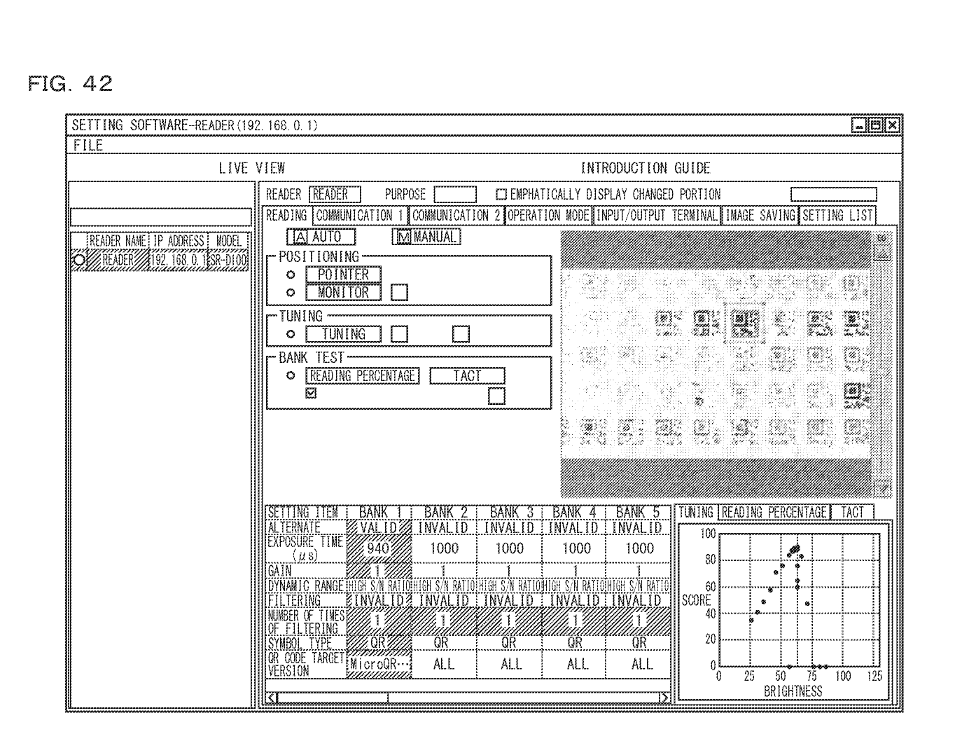

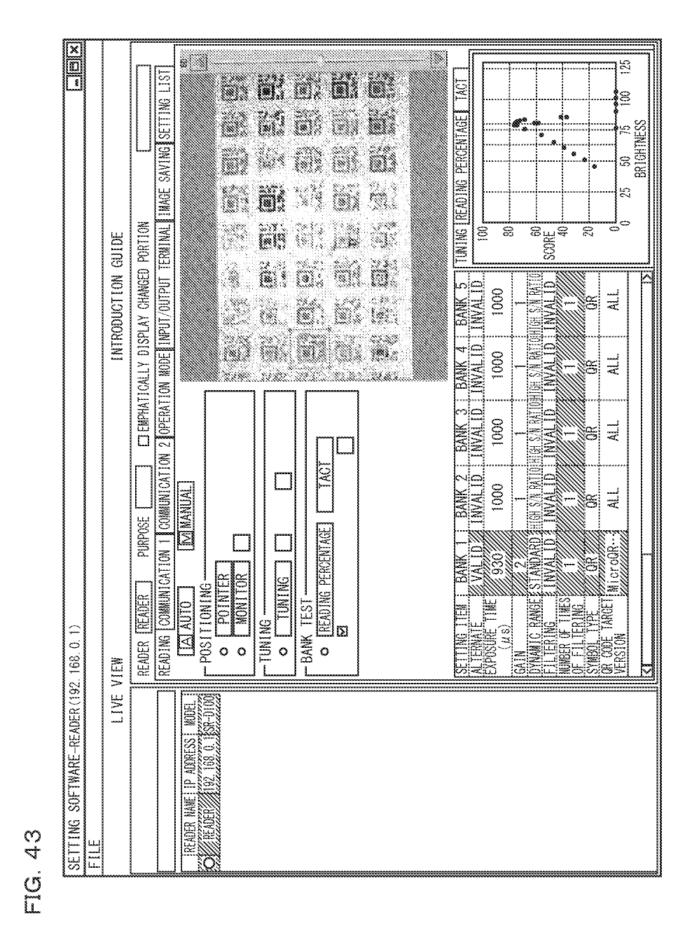

FIGS. 42 and 43 show a user interface screen when each of the codes is subjected to the tuning processing. A list of the images of the extracted codes is displayed in an upper right portion of the screen, and the image during the tuning processing is surrounded, for example, by a red frame or the like. In the tuning processing in which the decoding is performed while changing the brightness, the barometer of the readability is displayed in a graph form in a lower right portion. A horizontal axis indicates the brightness, and a vertical axis indicates the barometer. In an illustrated example, the term “score” is used. The above-described score is calculated based on an area (a value of integral) surrounded in this graph. In the comparison between FIGS. 42 and 43, although the peak of the barometer of the readability is the same, the area is larger in FIG. 42, and thus, it is determined that the code surrounded by the red frame in FIG. 42 is excellent in the reading stability of the bar code reader 2 with regard to the way to throw the illumination. Information of the code selected by the user may be supplied to the laser marker by connecting the personal computer 3 to the laser marker (not shown) to be reflected on the setting of the laser marker, as needed.

For evaluation of the code, while in the above embodiment, the barometer of the readability is calculated by changing the “brightness”, the barometer of the readability may be found by changing the lighting pattern, and further, from this barometer, the score indicating the reading stability may be found. Similarly, for example, the barometer of the readability may be found by changing the filtering, and further, from this barometer, the score indicating the reading stability may be found. Obviously, the barometer of the readability may be found by changing the brightness and the lighting pattern, and further, from this barometer, the score indicating the reading stability may be found. In this manner, the barometer of the readability is found by changing one or a plurality of imaging parameters, and further, the score indicating the reading stability is found from this barometer, by which the objective, appropriate evaluation of the code can be provided to the user.

According to the present invention, the code such as the bar code and the QR code is evaluated, and the result is applied to the processing condition setting of the user.

What is claimed is:

1. A code quality evaluating apparatus that is connected to an optical information reading apparatus, and acquires images picked up by the optical information reading apparatus to evaluate quality of codes included in the picked-up images, the code quality evaluating apparatus comprising:
an image taking-in device that takes in the picked-up images obtained by the optical information reading apparatus imaging the codes given to a work;
a code extracting device that extracts the readable codes from the picked-up images;
a score calculating device that performs reading trial to the codes extracted by the code extracting device while changing an imaging parameter, and calculates scores of reading stability of the extracted codes with respect to change of the imaging parameter, based on results of the reading trial; and
a display device that displays the images of the codes together with the scores calculated by the score calculating device.

2. The code quality evaluating apparatus according to claim 1, wherein the code extracting device extracts the readable codes by performing the reading trial while changing brightness for the codes.

3. The code quality evaluating apparatus according to claim 1, wherein the score calculating device performs the reading trial while narrowing down a reading region to each of the codes extracted by the code extracting device and changing the brightness.

4. The code quality evaluating apparatus according to claim 1, wherein the score is calculated based on a barometer of readability by the reading trial.

5. The code quality evaluating apparatus according to claim 4, wherein the scores are displayed as numeric values on the display device.

6. The code quality evaluating apparatus according to claim 5, wherein a list of the numeric values of the scores is displayed on the display device.

7. The code quality evaluating apparatus according to claim 4, wherein the scores are displayed in a graph on the display device.

8. The code quality evaluating apparatus according to claim 1, wherein the images of the extracted codes, the list of the numeric values of the scores, and the graph display of the scores are simultaneously displayed on the display device, and when one of the image of each of the codes, the numeric value of each of the scores, and the graph display of the scores is selected, the other two is emphatically displayed.

9. The code quality evaluating apparatus according to claim 8, wherein a portion where the images of the codes are displayed in the display device can be separated into at least two screens, and a plurality of codes given to a first work are displayed on a first separated screen, and a plurality of codes given to a second work different from the first work are displayed on a second separated screen.

10. The code quality evaluating apparatus according to claim 1, wherein the code is a code given to a test piece of the work by a sample processing function of a laser marker.
